(19) United States
(12) Patent Application Publication
(10) Pub. No.: US 2014/0317192 A1
(43) Pub. Date: Oct. 23, 2014

(54) APPARATUS, SYSTEM AND METHOD FOR PROVIDING LATENT TRIGGERS FOR CELEBRATING PAST AND RECURRING EVENTS

(71) Applicants: Kenneth David Wallach, New Hyde Park, NY (US); Benjamin Scott Klein, Little Neck, NY (US)

(72) Inventors: Kenneth David Wallach, New Hyde Park, NY (US); Benjamin Scott Klein, Little Neck, NY (US)

(21) Appl. No.: 14/260,135

(22) Filed: Apr. 23, 2014

Related U.S. Application Data
(60) Provisional application No. 61/815,170, filed on Apr. 23, 2013.
(60) Provisional application No. 61/827,964, filed on May 28, 2013.

(51) Int. Cl. H04L 29/06

(52) U.S. Cl. CPC H04L 65/403
USPC 709/204

(57) ABSTRACT

An apparatus, system and method of providing a latent celebration of memorable events, or a recurring celebration of an event in a timely manner, which allows for a determination of a latency or recurring period, whereupon remembrances, such as photos, may be shared amongst the celebrants.

### RELATED APPLICATIONS

This application claims the benefit of U.S. Provisional Application Ser. No. 61/815,170 filed Apr. 23, 2013, entitled “An Apparatus, System, and Method for Providing Latent Triggers for Celebrating Past and Recurring Events” and U.S. Provisional Application Ser. No. 61/827,964 filed May 28, 2013, also entitled “An Apparatus, System, and Method for Providing Latent Triggers for Celebrating Past and Recurring Events”, both of which are hereby incorporated by reference in their entireties.

### BACKGROUND OF THE INVENTION

1. Field of the Invention

The present invention is directed to the celebration of memorable events, and, more particularly, to an apparatus, system and method for providing latent triggers for celebrating past and recurring events.

2. Description of the Background

It is presently known to take photographs and videos (hereinafter alternately and collectively referred to solely as “photographs” or “photos”) of memorable events, and to share those photographs as remembrances of those events. It is further known to engage in electronic social networking, wherein such photographs and remembrances are often shared as between friends, family, colleagues, and the like who are connected through such social networks.

However, once photos or like remembrances are shared, typically in the near term following an occurrence, they are often forgotten and not remembered again for months or years. As such, the need exists for an apparatus, system and method of providing a latent celebration of memorable events, or a recurring celebration of an event in a timely manner, which allows for a determination of a latency or recurring period, whereupon remembrances, such as photos, may be shared amongst the celebrants.

### SUMMARY OF THE INVENTION

The present invention is and includes an apparatus, system and method of providing a latent celebration of memorable events, or a recurring celebration of an event in a timely manner, which allows for a determination of a latency or recurring period, whereupon remembrances, such as photos, may be shared amongst the celebrants.

The present invention may employ computer- and network-implementations to provide photo latency, such as for the purpose of revising, revisiting or renewing memories, experiences, and/or shared experiences. Latent photos include those photos that are enjoyed, delivered, viewable, or the like, upon expiration, again upon expiration, or only upon expiration, of a particular timeframe. In preferred embodiments, the delivery, enjoyment, or viewing of such latent photos may ultimately be provided in a mobile application, or “app,” provided on a mobile device. Alternatively, delivery or viewing of the latent photo may be provided “extra-app”, that is, outside of an app in which the latency is defined. Extra-app delivery may occur to, for example, an email, a secure web site having predetermined accessibility, or the like, and thus such an extra-app delivery may occur to a desktop or laptop computer, a tablet computer or smartphone, or the like.

### BRIEF DESCRIPTION OF THE FIGURES

The present invention will be described in conjunction with the incorporated figures, in which like numerals represent like elements, and in which:

FIGS. 1-50 illustrate exemplary aspects of the present invention.

### DETAILED DESCRIPTION OF THE INVENTION

It is to be understood that the figures and descriptions provided herein may have been simplified to illustrate elements that are relevant for a clear understanding of the present invention, while eliminating, for the purpose of clarity, other elements found in typical systems and methods in the prior art. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art.

A computer-implemented platform, system, and methods are disclosed for providing latent “gifting,” “unwrapping,” or refreshing of memories, shared experiences or experiences, preferably in the form of photographs (also referred to as “photos”). This latent providing of memories or experiences may occur intra-application (“app”), may be requested intra-app and delivered extra-app, may be requested extra-app and delivered intra-app, or may be requested and delivered extra-app, by way of example. As used herein, an app may preferably indicate an application on a mobile device, such as a smartphone, PDA, or a tablet computer, although, in certain embodiments an app may be partially or entirely included on a stationary device, such as a desktop or a laptop computer.

The described computer-implemented embodiments are intended to be exemplary and not limiting. As such, it is contemplated that the herein described systems and methods may be adapted to provide many types of users with access and delivery of many types of services, and can be extended to provide enhancements and/or additions to the exemplary services described. The disclosed systems and methods are intended to encompass all such extensions, the protected scope of which are defined by the appended claims.

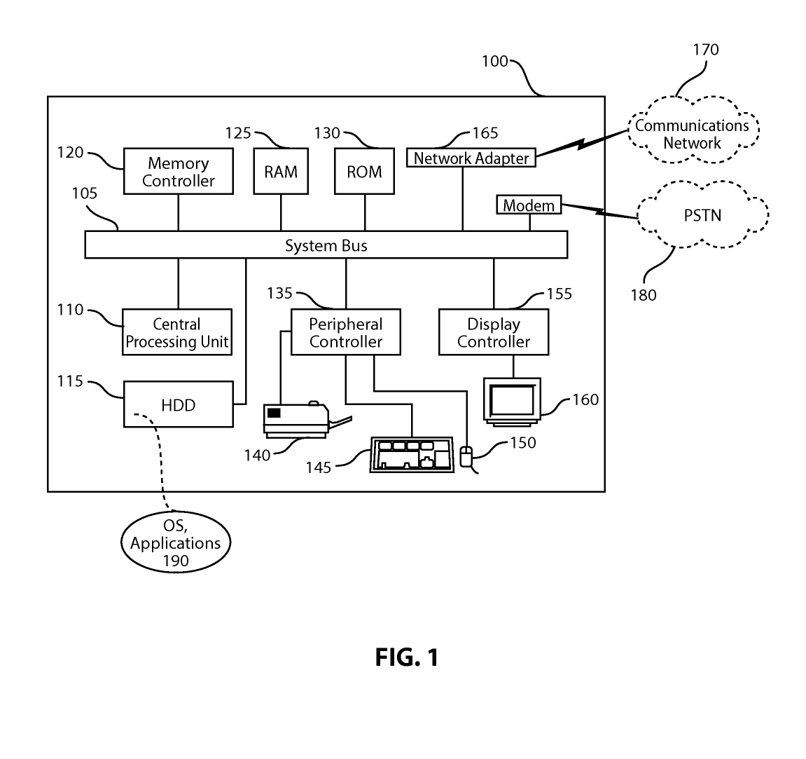

FIG. 1 depicts an exemplary computing system 100 that may be used in accordance with herein described system and methods. Computing system 100 is capable of executing software, such as by providing an operating system (OS) and a variety of executable computing applications, or apps, 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel or touch display, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the data discussed herein. Communications network 170 may provide user access to computing system 100 with means of communicating and transferring software and information electronically, and may be coupled directly to computing system 100, or indirectly to computing system 100, such as via PSTN or cellular network 180. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations. That is to say, the inventive concepts described herein may be implemented in various computing environments using various components and configurations.

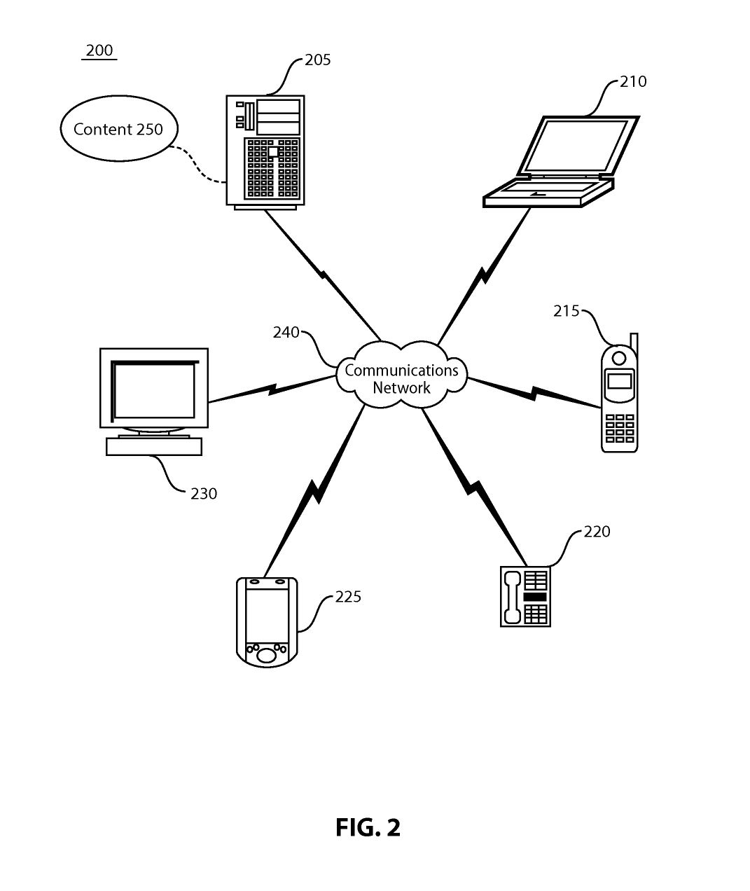

As shown in FIG. 2, computing system 100 may be deployed in networked computing environment 200. In general, the above description for computing system 100 applies to server, client, and peer computers deployed in a networked environment, for example, server 205, laptop computer 210, desktop computer 230, and various mobile computing devices 215. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone/smartphone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver and/or or communicate via applications specifically designed for mobile client devices, such as, for example, device 215. Client devices 215, 225 may be any mobile or stationary computer, computing device, telephone, PDA, tablet or smart phone and may have any device compatible operating system. Such operating systems may include, for example, Windows, Symbian, RIM Blackberry OS, Android, Apple iOS, Windows Phone, Palm webOS, Maemo, bada, MeeGo, Brew OS, and Linux. Although many mobile operating systems may be programmed in C++, some may be programmed in Java and .NET, for example. Some operating systems may or may not allow for the use of a proxy server and some may or may not have encryption. Of course, because many of the aforementioned operating systems are proprietary, in certain prior art embodiments server 205 delivers to client devices 215, 225 only those applications and that content applicable to the operating system and platform communication relevant to that client device 215, 225 type.

In short, the present invention may employ the foregoing and like computer- and network-implementations to provide (and/or to allow a user to create) photo latency, such as for the purpose of revising, revisiting or renewing memories, experiences, and/or shared experiences. As used herein, latent photos include those photos that are enjoyed, delivered, viewable, or the like, upon expiration, again upon expiration, or only upon expiration, of a particular timeframe. In preferred embodiments, the delivery, enjoyment, or viewing of such latent photos may ultimately be provided in a mobile application, or “app,” provided on a mobile device, such as a smartphone, computing tablet, or the like. Alternatively, delivery or viewing of the latent photo may be provided “extra-app”, that is, outside of an app in which the latency is defined. Extra-app delivery may occur to, for example, an email, a secure web site having predetermined accessibility, or the like, and thus such an extra-app delivery may occur to a desktop or laptop computer, a tablet computer or smartphone, or the like.

The photo latency period, i.e., a delivery time, may be precisely or approximately defined. Correspondingly, the photo latency period may be a certain timeframe, i.e., 30 days, 365 days, etc., or may be corresponded to a certain date, i.e., December 25, February 14, or an Anniversary or Birthday date, or may be corresponded to a particular event, i.e., the next election, the next snowstorm in a certain area (such as in a certain zipcode), the next airing of a certain television show, a release of a certain movie or movie sequel, a purchase, such as of a home or a car, a return to a certain location (such as may be tracked via a smartphone GPS), etc.

Further, a latent photo may be delivered to or viewable by one or more of the taker of the photo, the owner or controller of the photo, a person in the photo, or a third party, for example, upon expiration of the latency period. As such, the latent photo may be delivered at the time of “unwrapping,” or may include delivery at a time prior to subsequent eligibility for “unwrapping,” or may be subject to an invitation to undertake an action in order to obtain the latent photo and allow for “unwrapping.” As used herein, an unwrapping may include a reveal, i.e., viewability, of the latent photo.

The following exemplary flow of screens is illustrative only. Further, reference will be made below to selection boxes, messages, indicators, and the like, oftentimes by reference to particular display items, such as a “green checkbox”, or an “inquiry box.” Those skilled in the art will appreciate that such references are exemplary in nature only, and are not to be deemed limiting as to the disclosed invention.

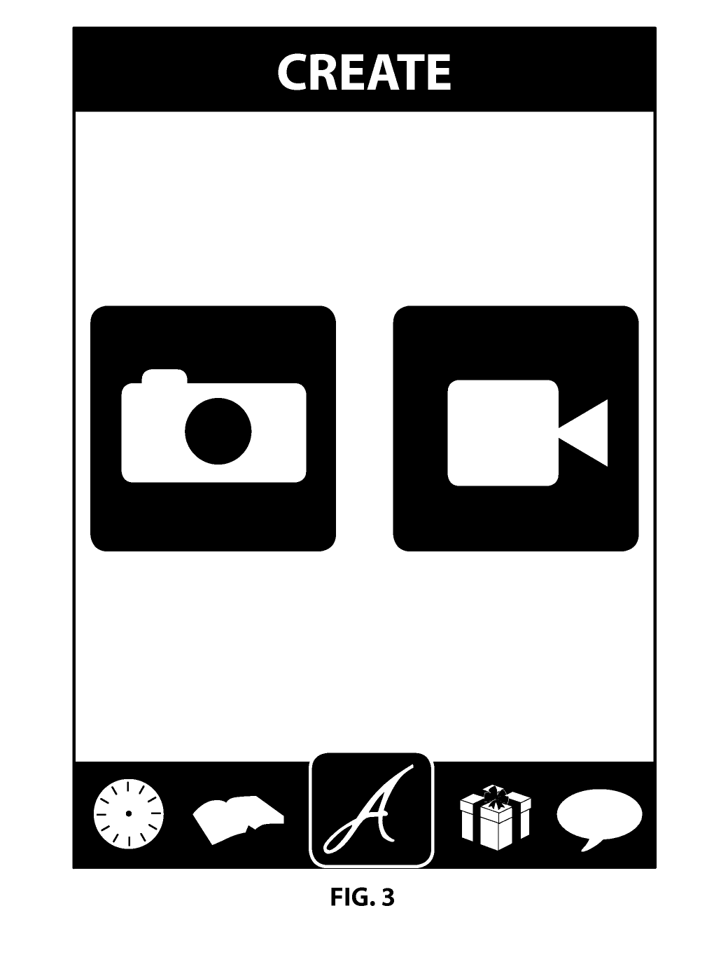

FIG. 3 is an illustrative screen shot of an exemplary system and method according to the present invention, such as may be provided intra-app on a mobile device. Illustrated in FIG. 3 is a pop-up graphic bar, such as may be provided each time the application is opened for the first time, or reopened (i.e., after the user was logged out, or executed a (−) from bottom of phone). That is, a graphical bar may be provided following a log-in or similar re-activation by the user, wherein the graphical bar may allow navigation of the app by the user.

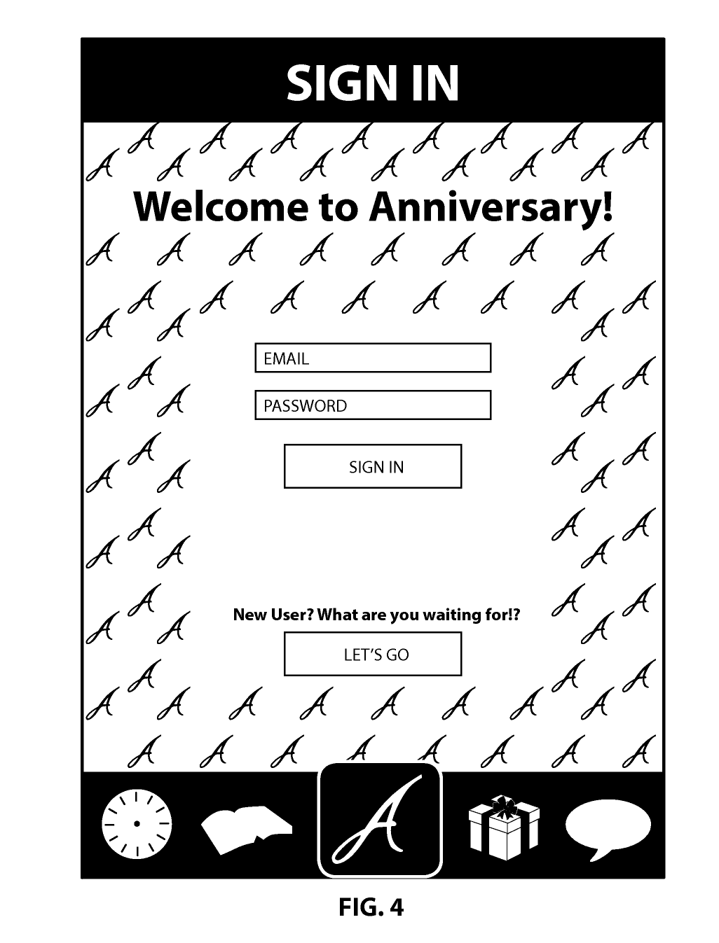

FIG. 3 further illustrates a “Create” screenshot that may appear each time the user presses the “A” at the bottom center of the screen, such as following a log in at FIG. 3B. A log-in may be comprised of his/her email address and password. Once logged in, a user may remain logged. If it is the user's first time on the app, the user may begin the sign up process. Returning to the illustration of FIG. 3, the user has the choice between photo (left center) or video (right center) to capture a specific moment. Once either icon is pressed, the mobile device's camera or video camera will be activated and ready for use, such as is illustrated in FIG. 4.

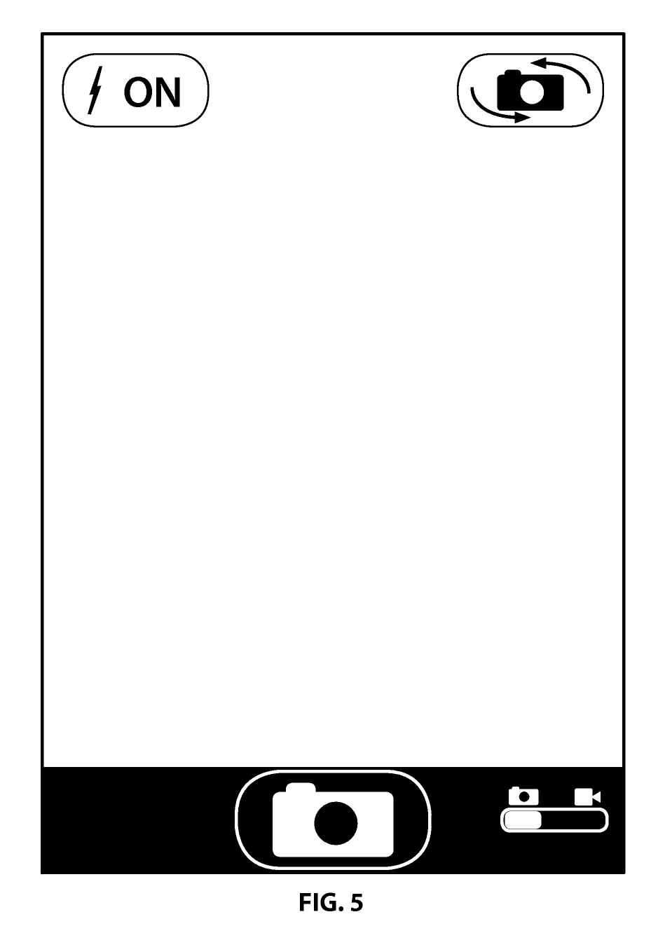

Once the photo or video is captured, the user may be redirected to the screen illustrated in FIG. 5. The photo or first frame of the video may appear at the top center of this screen. If the user took a video, the first screenshot may have a standard playback button (sideways triangle within a circle), which may allow for viewing in the entirety. Relatedly, a freeze frame from the video may be shown to indicate the contents of the video. If the user wishes to retake the photo or video, he or she may simply press the “back” button at the top left of the screenshot (represented with a X in the example shown). This may redirect the user to back to the mobile device's camera or video camera so that she may retake her photo, such as her anniversary photo.

Form the illustrative screen of FIG. 5, and once the user is satisfied with the photo or video, he or she may then have the option to insert a caption for the photograph or video by pressing the white box underneath the screenshot. Once the box is pressed, the mobile device's keyboard will appear, and the user can type a caption, such as a limited number of characters, such as up to 40 characters. The user may also “tag”, or celebrate with, any other individual who also uses the application. In order to have the ability to celebrate with another, the individual being tagged may need to be in the user's circle, as discussed further below. Further, the user may select the manner in which the other will be invited to celebrate, such as via the screen illustrated in FIG. 5B.

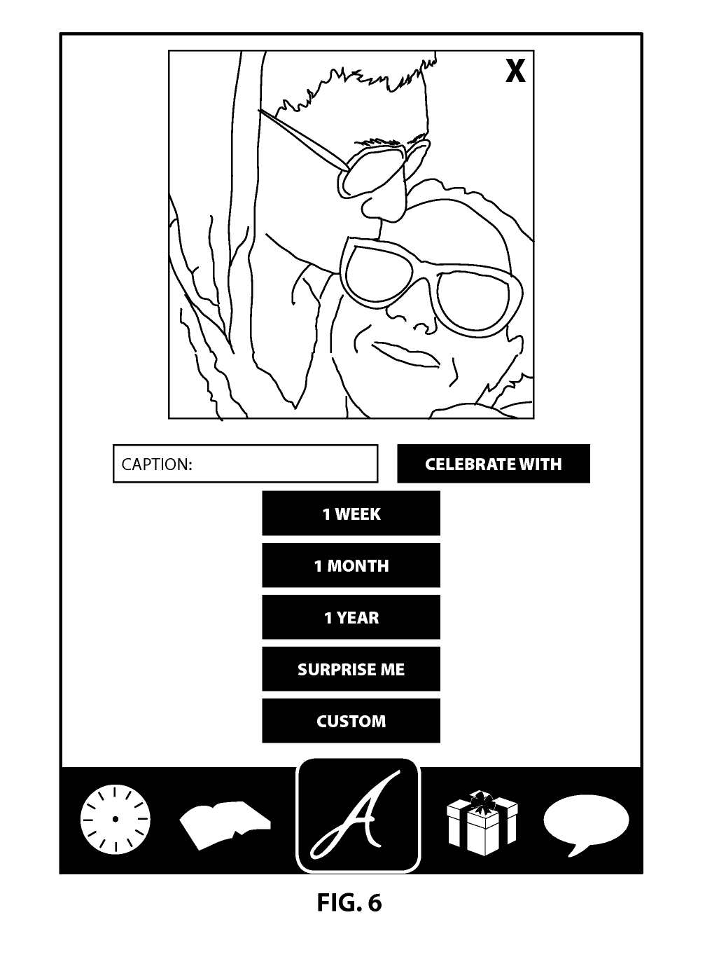

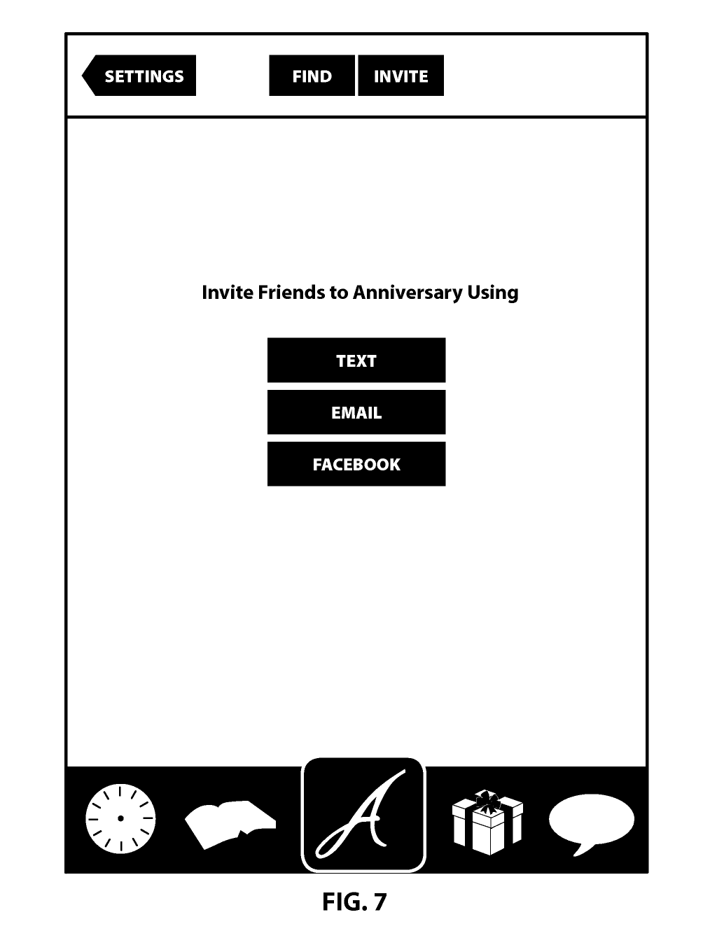

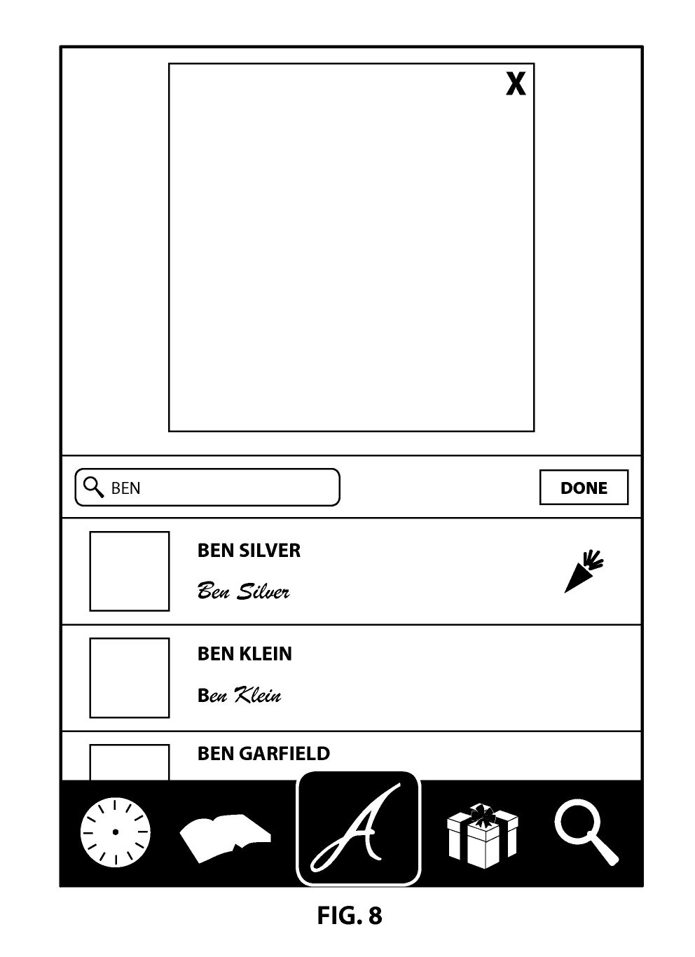

To select the individual(s) the user wants to celebrate with, the user may push a button that says “celebrate with” in the illustration, at which time the screenshot of FIG. 6 may appear. When the user has selected those who he/she wishes to celebrate with, the user may then select a personalized time period, or latency period. He or she may have a choice between 1 week, 1 month, and 1 year, or upon any date or occurrence. That is, the user may select a custom date by selecting custom. If “custom” is selected, a virtual calendar may pop up, such as is illustrated in FIG. 7, and the user may select the specific date he/she wishes to have a memory delivered. The user may also select Surprise Me—this option may keep the user blind to the future date of reception. Once the time latency period is selected, a small confirmation box may appear, such as is shown in the example of FIG. 8.

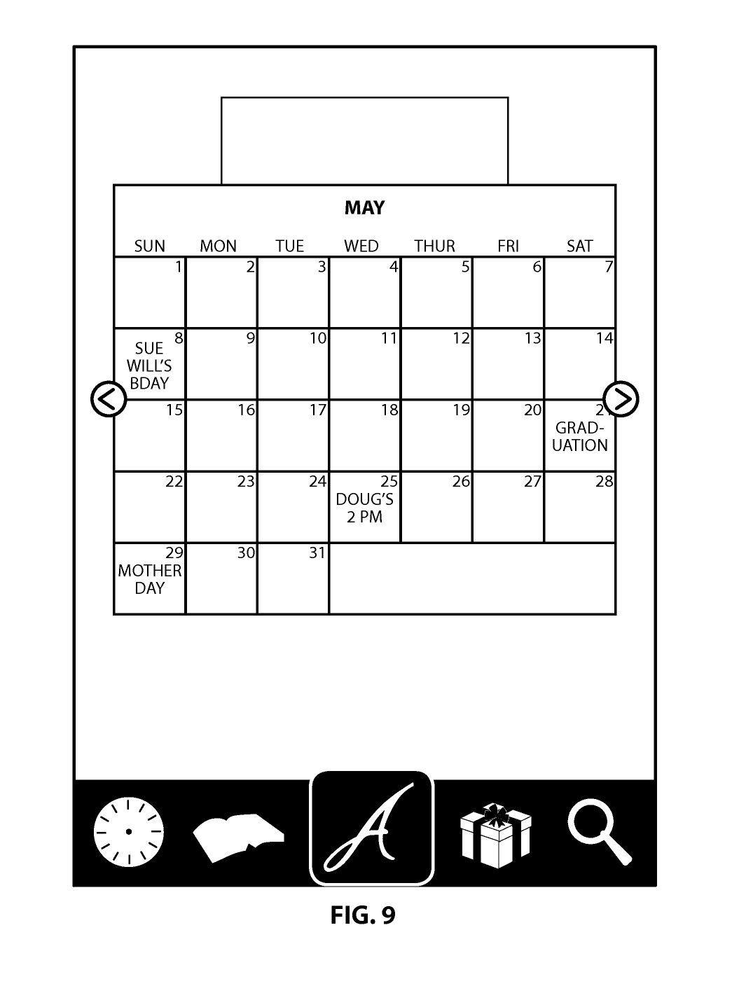

Once the latency period is confirmed, the application may redirect to a “gift-box” screen, such as that of FIG. 9, and a “sending-progress bar” may appear at the top of the screen. Once the progress is complete, a “postal stamp” may appear over the present (as illustrated), and those who were involved in this exemplary Anniversary may be listed to its left. In certain embodiments, the anniversary may not be hyperlinked, and thus, once the Anniversary is sent, it may irretrievable up until the date it is sent back, i.e., until the close of the latency period.

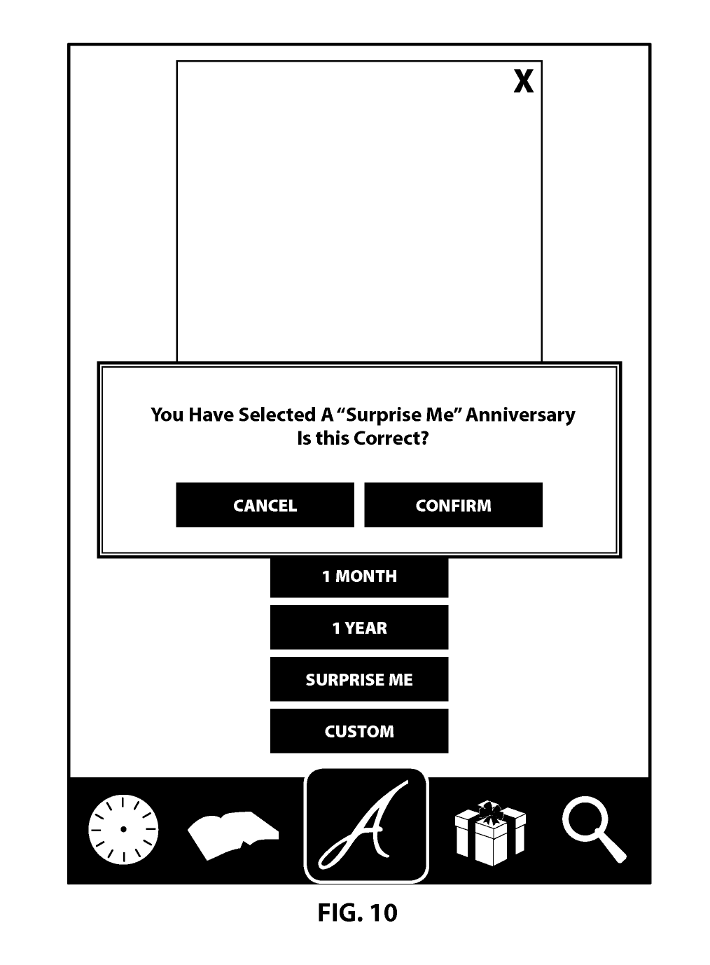

FIG. 10 is an exemplary illustration of the “page view” of a user's Anniversary. The date the photo was taken may be provided above the photo/video, and the caption may be provided below (a user may also click one or more times to enlarge the photo or play the video). Below the “page” may be provided the celebration “cone,” and additionally those who the user “celebrated with.” Further, those who are “involved” in the Anniversary may be able to comment on it or discuss it, such as in a comment box and/or a chat window/icon provided below this Anniversary.

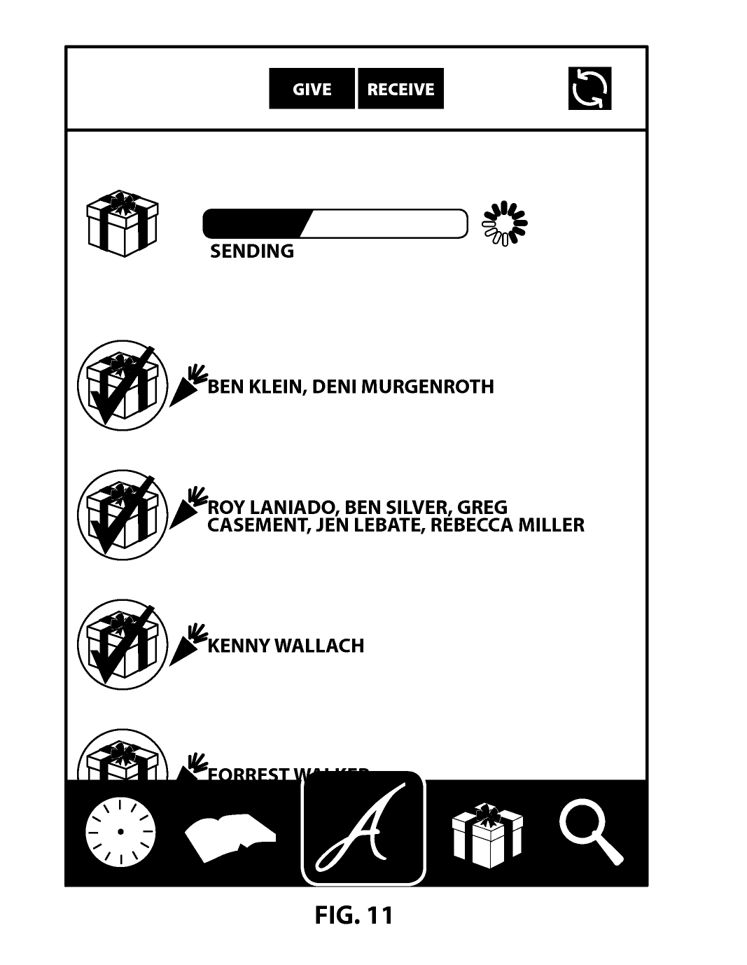

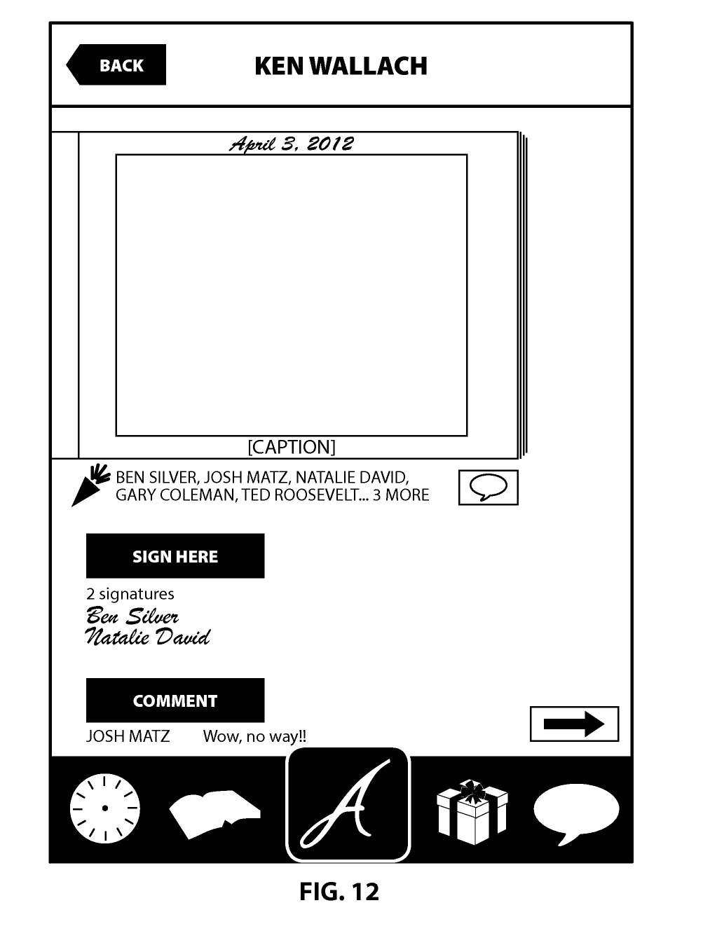

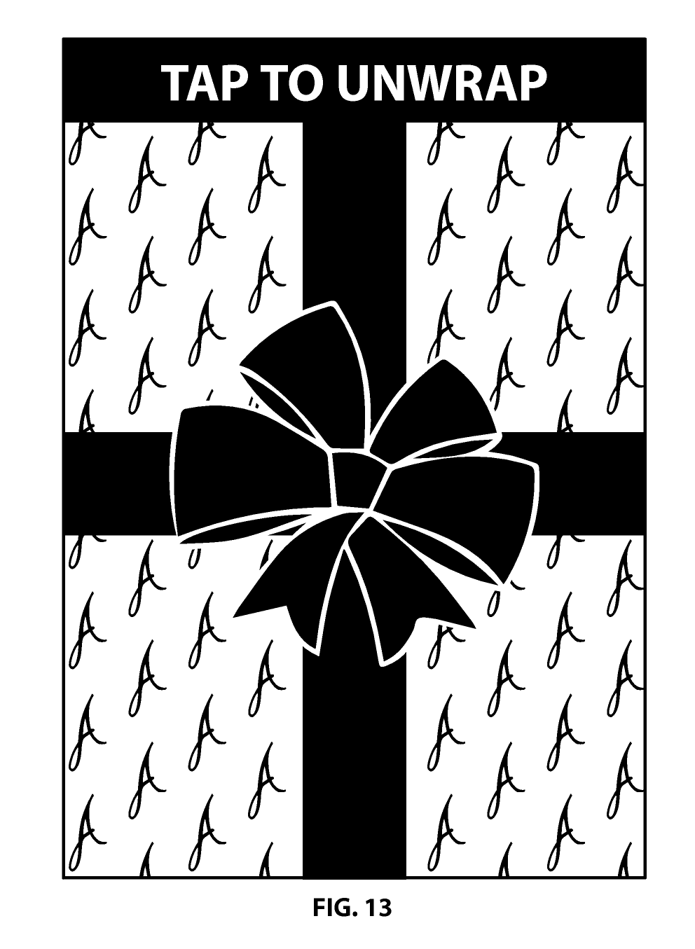

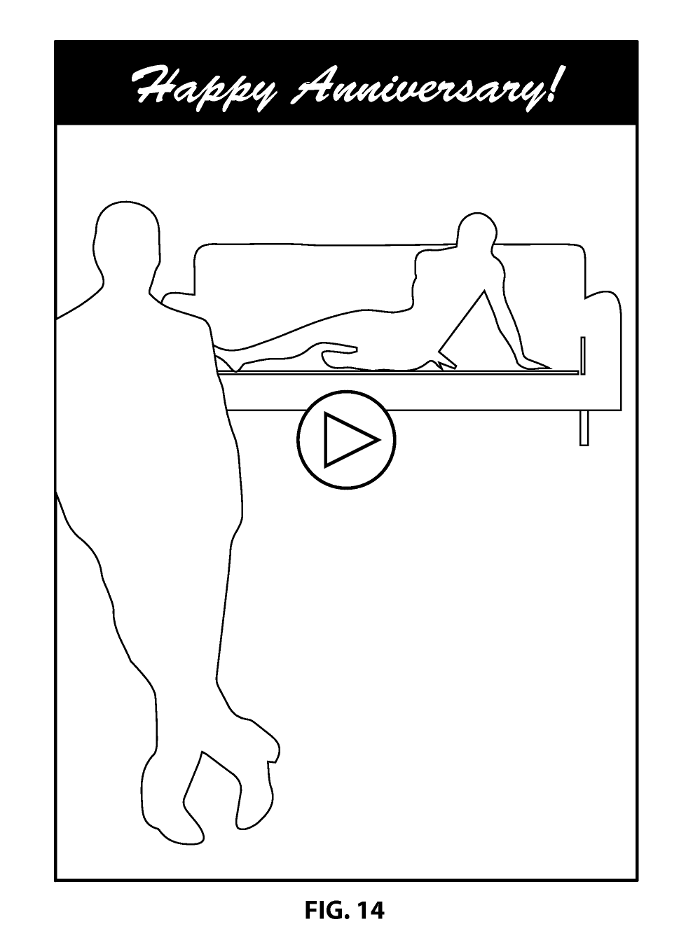

Once the user opens a new Anniversary, such as by “unwrapping” the screen of FIG. 11, they may be redirected to the viewing screen of FIG. 12. That is, the user may tap anywhere on the screen of FIG. 11, and the wrapping paper may virtually “unwrap”, revealing the Anniversary. The media may then take up the screen for a time period, such as a 2 full seconds, and the photo or video may “play,” such as shown in FIG. 13. Once the anniversary is viewed, it may be subjected to a variety of functions to Save, Forward, or the like, as is illustrated in the exemplary embodiments of screens in FIGS. 14, 15 and 16.

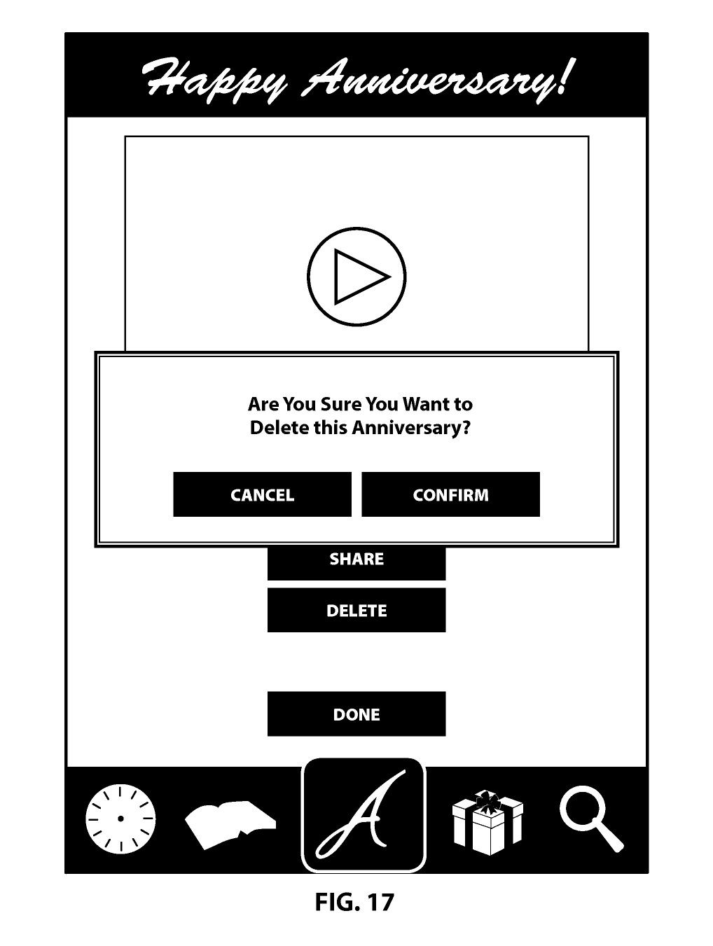

The user may develop a “circle” for communication, such as for delivering latent photos, chatting about such photos, and the like. For example, in the afore-discussed example, if the user is brought to another user's profile that is not in his/her circle, the user may request to bring that other into his/her circle, such as by sliding that other's profile picture into the circle screen or otherwise adding to the circle. An exemplary circle is shown in FIG. 17.

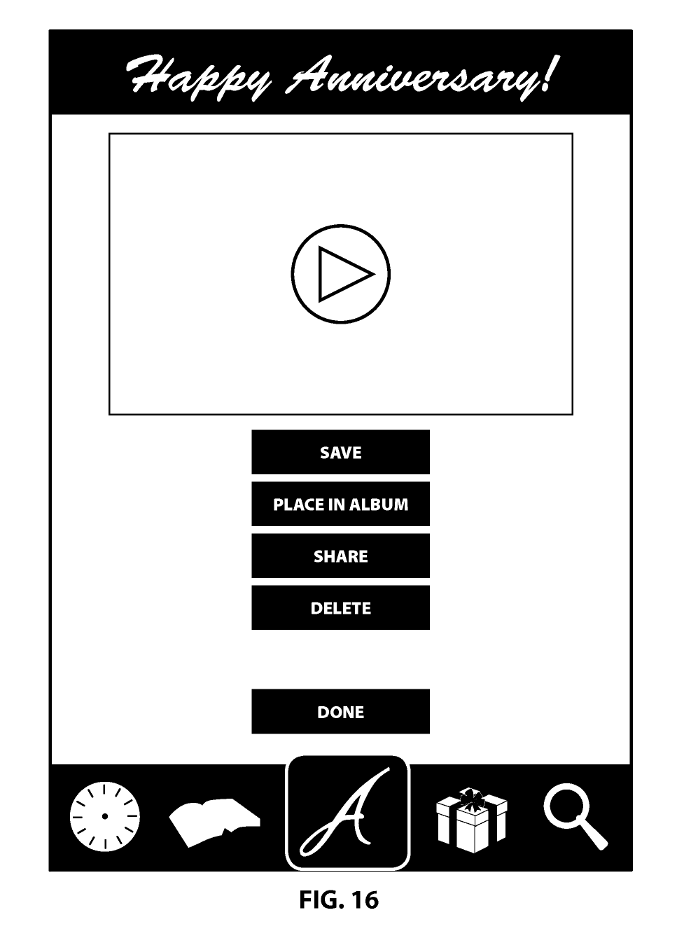

Further, if the user selects “celebrate with” when creating a new Anniversary, she may be redirected to the screen of FIG. 6. The photo may stay as a small image at the top, while the user can search for other users in his/her circle to select. When the user selects a name, an indication of selection may appear, that selected user may then appear under the photograph (not illustrated), and the user may be enabled to select more users to celebrate with. When she has finished, she may press the “Done” button, and may be redirected back to the screen of FIG. 16, for example.

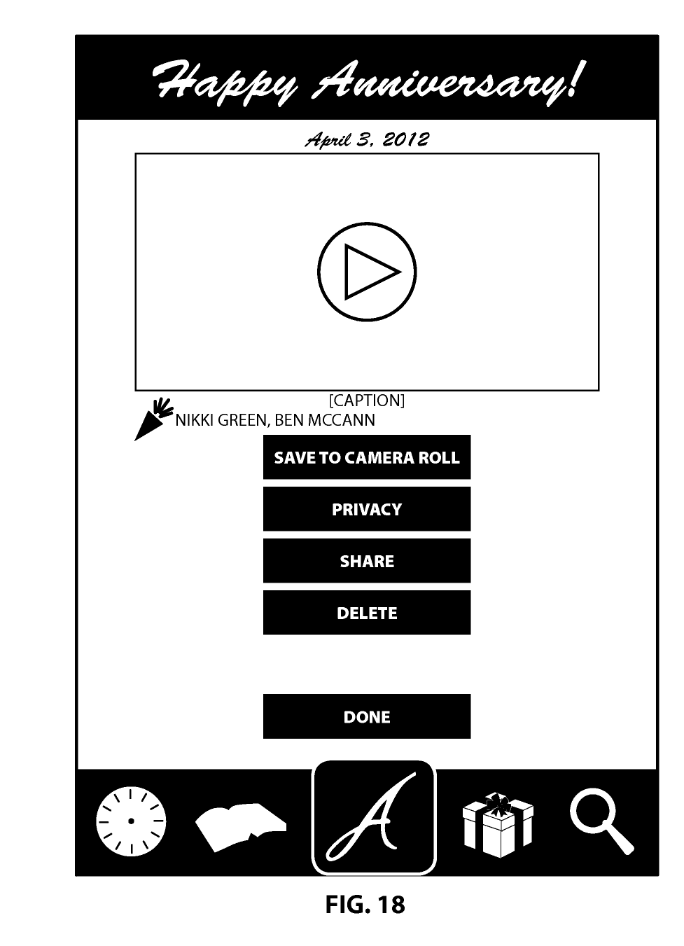

When a user receives a new Anniversary, a “1” (or if they have not opened previous Anniversaries, whatever appropriate number) or like indicator may appear, such as above a gift icon, to indicate that a new Anniversary has been received. When the user selects the icon, she may brought to a screen such as that illustrated in FIG. 18, and may select an Anniversary to open. The already opened Anniversaries may be listed underneath, and, if clicked, may bring them to that Anniversary's album view, such as is illustrated in FIG. 10.

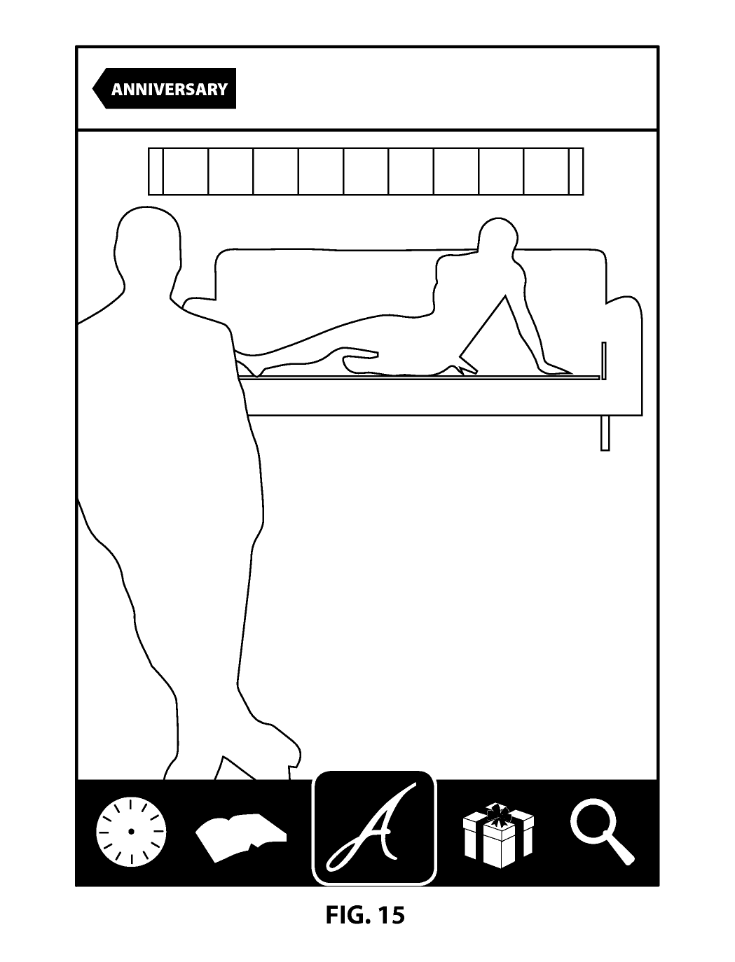

If a user wishes to delete an Anniversary when he/she receives it (so it will not appear on her Anniversary page, or be eligible for chats), the user may click the delete option. Once the option is clicked click, a warning message may pop-up. By pressing confirm, the Anniversary may be deleted, as illustrated in FIG. 15. If the user selects confirm, he/she may be redirected, such as to the screen of FIG. 18.

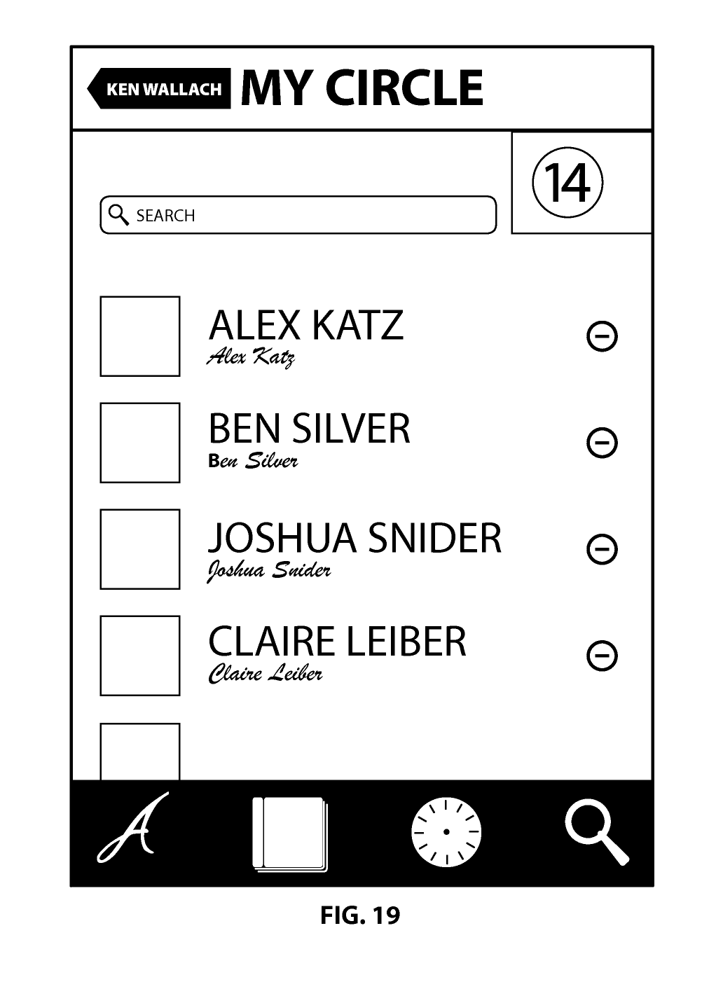

When a user opens up a new anniversary, the media may take up the full screen for a time period, after which the user may be redirected to the screen of FIG. 16, for example. On this screen, if the user wishes to view the media full size, he/she can click on the image/video. To exit full screen, the user may touch the screen again. If the user wishes to save the Anniversary to her phone's internal camera roll, she may select “save to camera roll”, and a green checkmark may appear to the left of the box. If one or more privacy options is selected, a green checkmark may appear to the left of the “privacy” box. If the user wishes to share the anniversary on other media, he/she may also select the share option. This may redirect the user to the screen of FIG. 19. If he/she successfully shares the anniversary with at least one option, a green checkmark may appear to the left of the box. If the user wishes to delete the Anniversary, he/she can select the “delete” box as discussed above.

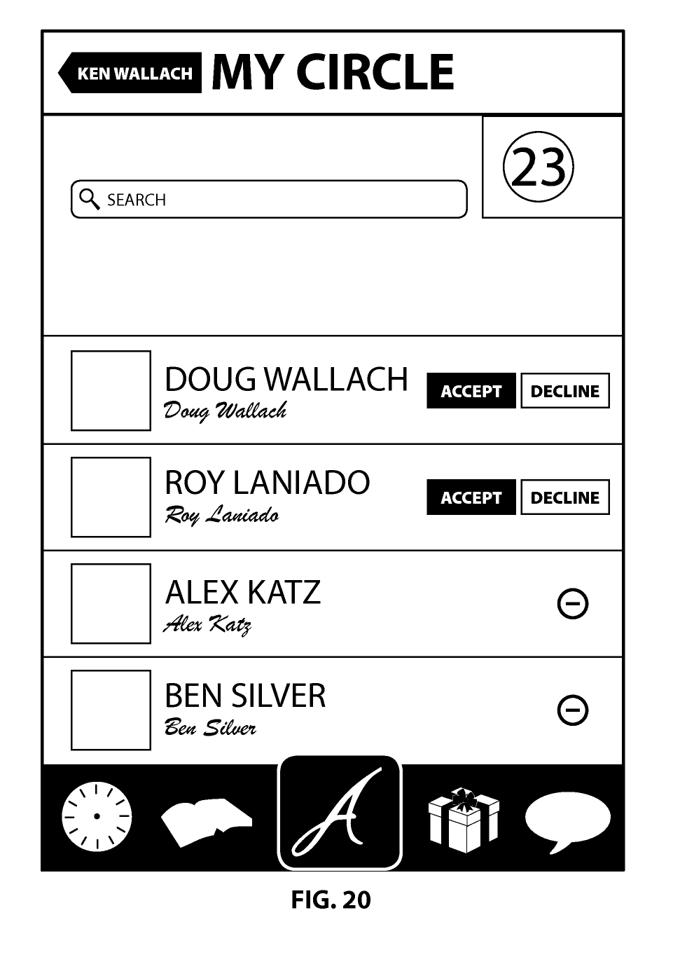

As referenced above, the screen of FIG. 17 is illustrative of a user wishing to view those who are in his circle, or remove someone from his circle. To land at the screen of FIG. 17, the user may click an indicator of persons in his circle, such as the circled number on the user's profile page as illustrated in FIG. 20, or a confirmation or deletion of a user's circle members as shown in FIG. 17B. The names in one's circle may appear in alphabetical order, with the top of the alphabet at the top of the list.

If the user wishes to remove someone from his/her circle, he can click the red (−) symbol to the right of the name, for example. A confirmation box (not illustrated) may appear, stating “Are you sure you want to remove John Smith from your circle? By doing so, all pending Anniversaries between you two will not be delivered, and access to each other's Anniversary Albums will be restricted.” [CANCEL] [REMOVE]. If the user selects remove, the user may be redirected back to the list of FIG. 17 and the name removed will not appear on the list, and all Anniversaries that he/she created and celebrated with that person will not be delivered to that person. For example, if the user created an Anniversary and celebrate with Nick, and two days later the user removed Nick from the user's circle, the Anniversary would only get sent back to user, and not to Nick. If the user created an Anniversary and celebrated with Nick and Joe, and decided to remove Nick from the user's circle, Joe and the user would still receive that Anniversary, but not Nick. However, if Joe creates an Anniversary, celebrates with Nick and the user, and the user removes Nick from his circle, all three would still receive the Anniversary.

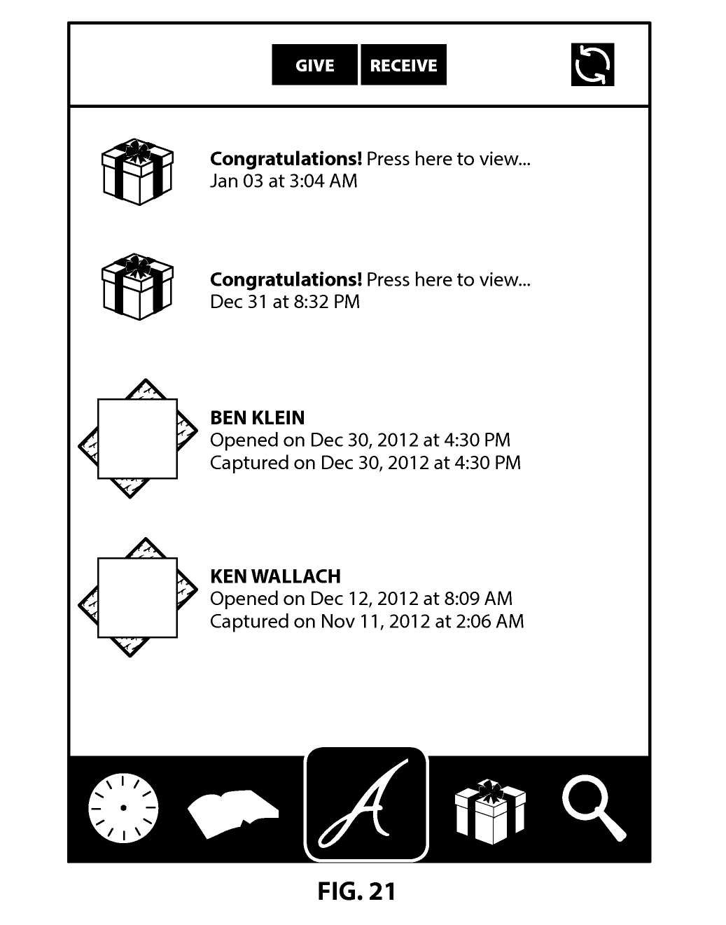

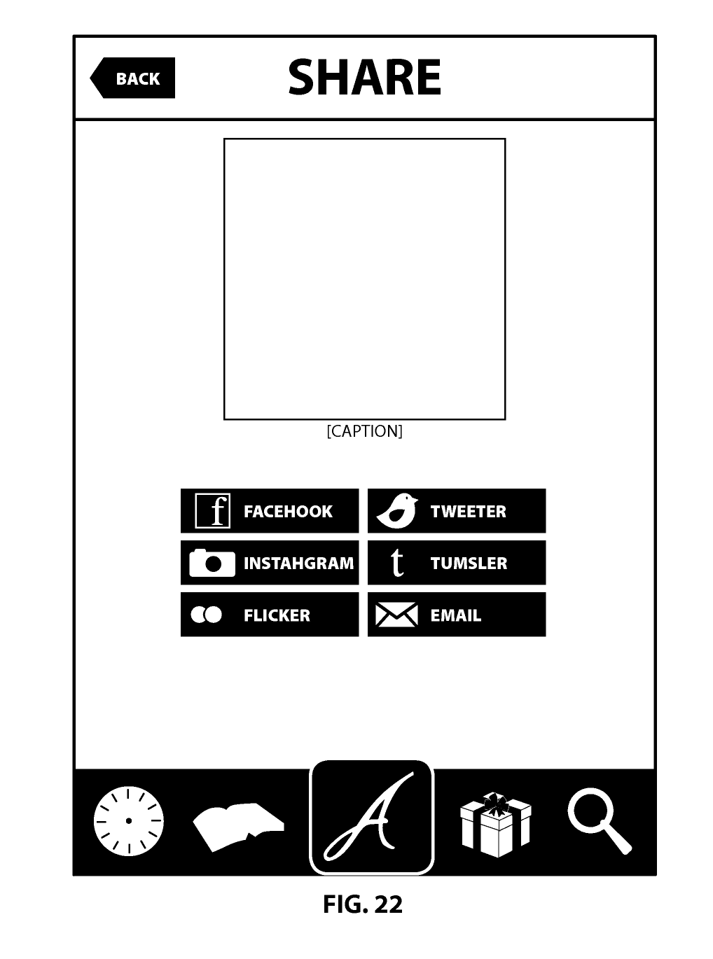

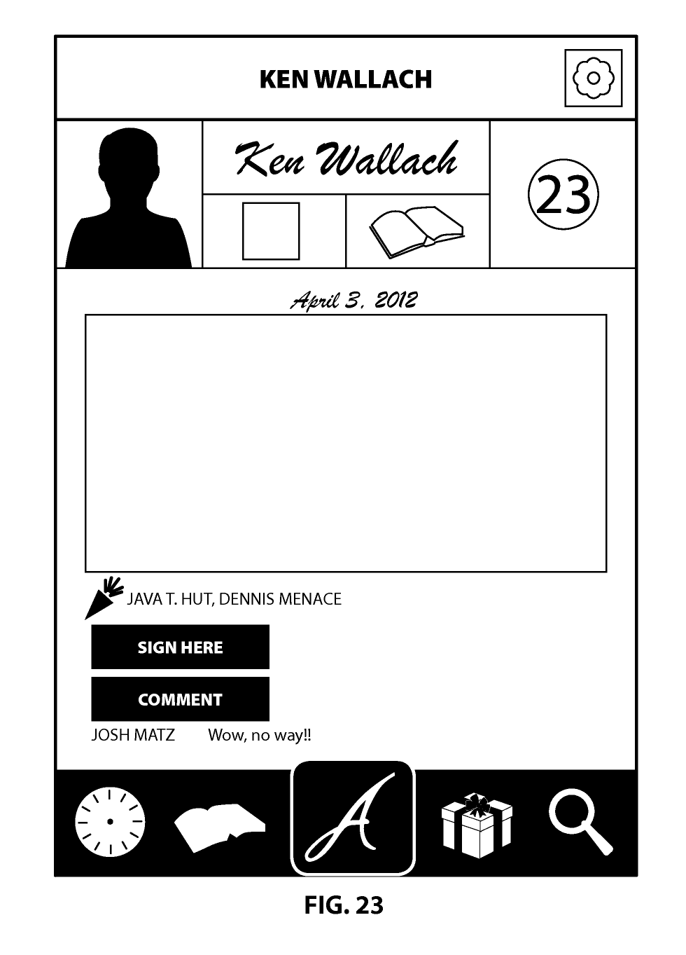

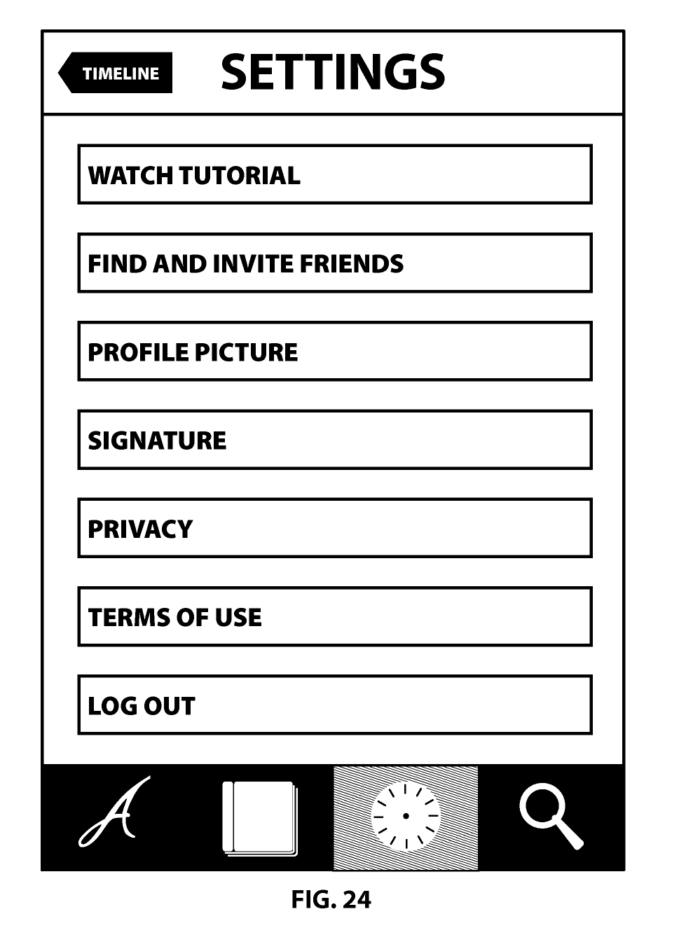

The user may additionally have a profile, and associated profile information, which profile may be modifiable. The user may access a profile, and other settings, such as security settings, via a screen such as that of FIG. 21. For example, a user may decide to change his/her profile picture (either from settings, or by selecting their picture on their profile) via the screen of FIG. 22. If “import from camera roll” is selected, the phone's internal camera roll may pop up, and he may select a photo. If “take new photo” is selected, the user may be redirected to the phone's camera. When the photo is taken, it may appear in the box. If “select from Album” is selected, the user may be redirected to FIG. 23, where the user can select any Anniversary photo (videos may be greyed out). If an Anniversary photo is selected, it will appear in the box. Other options may include, for example, “import from Facebook”. If “Remove Current Photo” (in RED) is selected, a pop-up confirmation screen of FIG. 24 may appear. When the user is satisfied with the profile picture, he can select “done” and be redirected to a previous screen. If the user remove his profile picture, and/or leaves it blank, the picture may appear as a silhouette animation, for example.

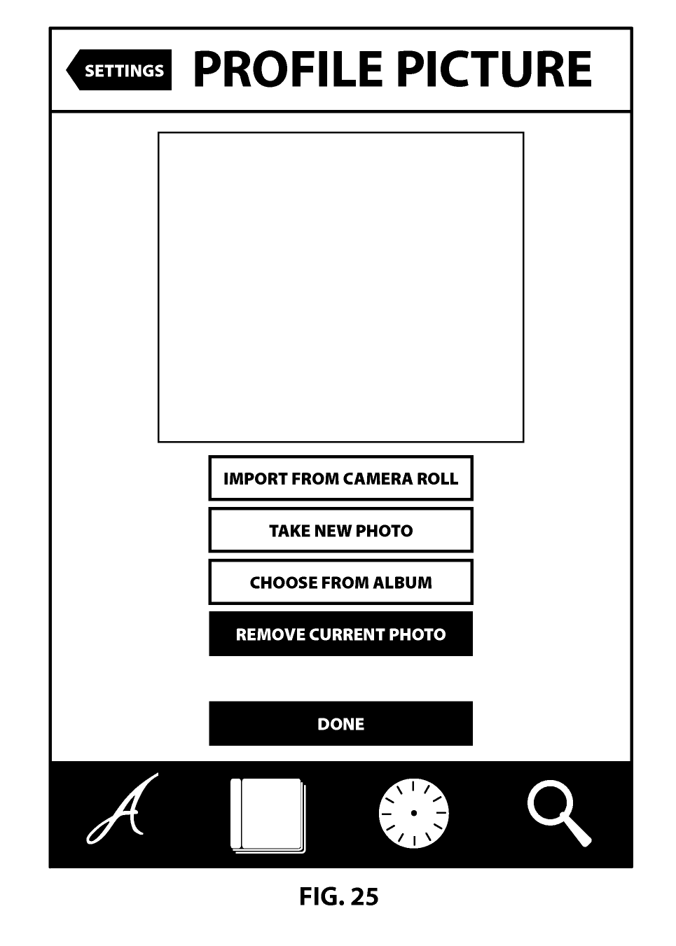

Because of the latent delivery of the instant invention, “unlocking” may be performed in order to have the user experience an Anniversary for the first time without waiting too long. The user's first Anniversary may be set as a “1-week Anniversary”, as shown in FIG. 25. Once this is done, each Anniversary (whether received or sent) may unlock one of those present boxes, and every time 2 present boxes are “unlocked”, the next option down may become available.

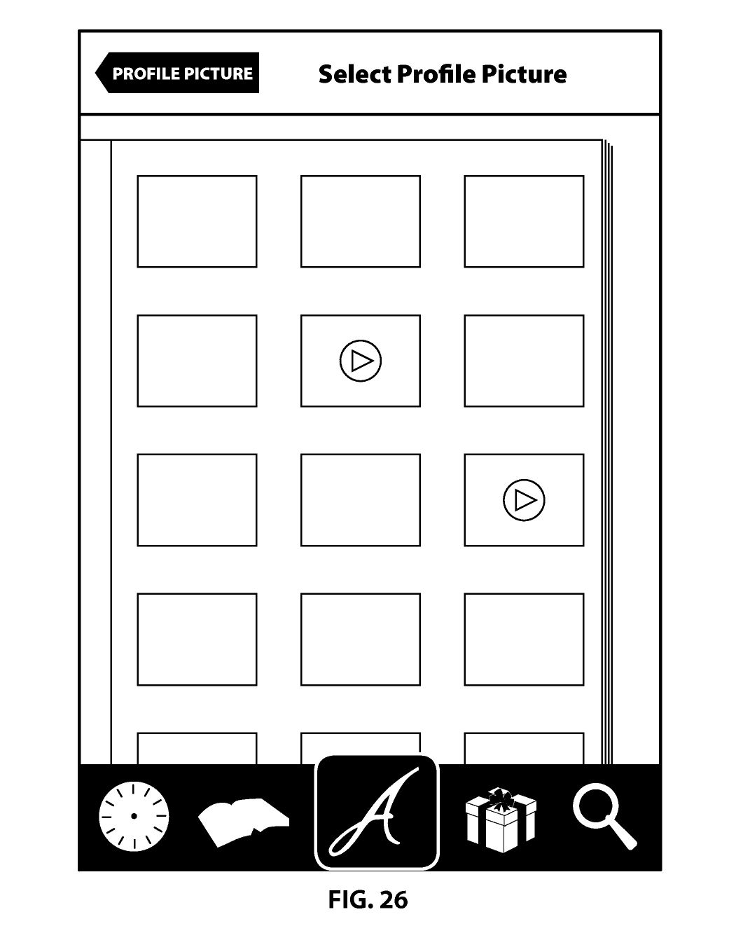

For FIG. 26, a user may select “Find and Invite Friends”. When “search” is selected, the device's keyboard may pop-up. The user can then type in a name, and all names on the app that match may appear. Underneath the search bar is an access contact list, and if friends have entered their phone numbers into the application when they signed up for the app, they will appear on this list. Below is an option for users to enter their own mobile numbers (if they have not already done so) so that they will be searchable for friends. If the user has already entered her number, the number will appear in “grey”, and can be changed if selected.

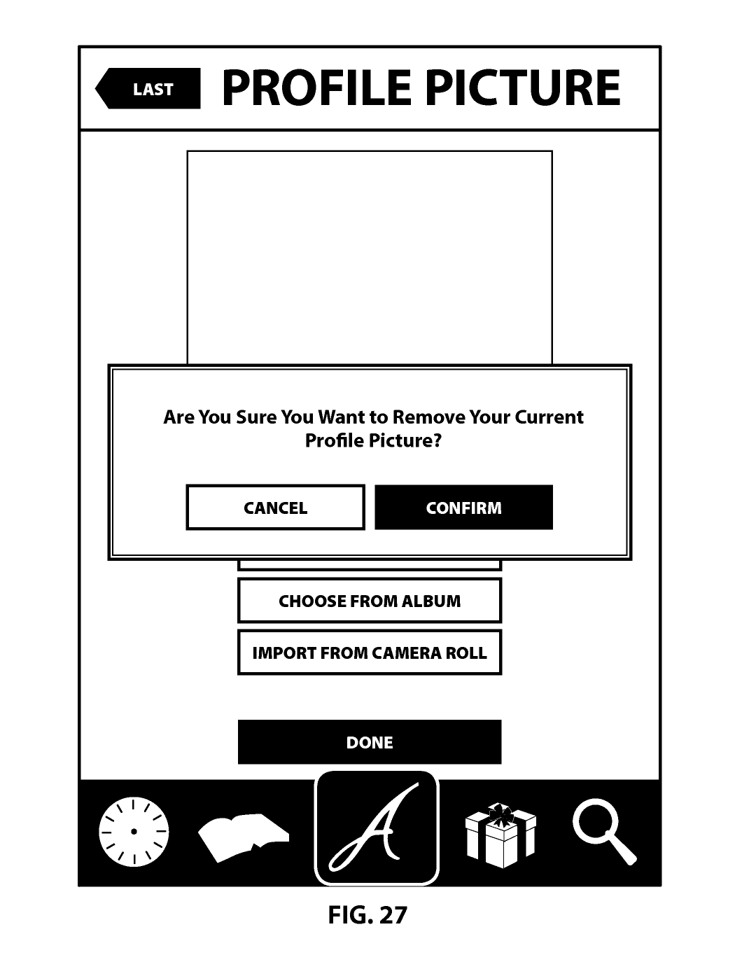

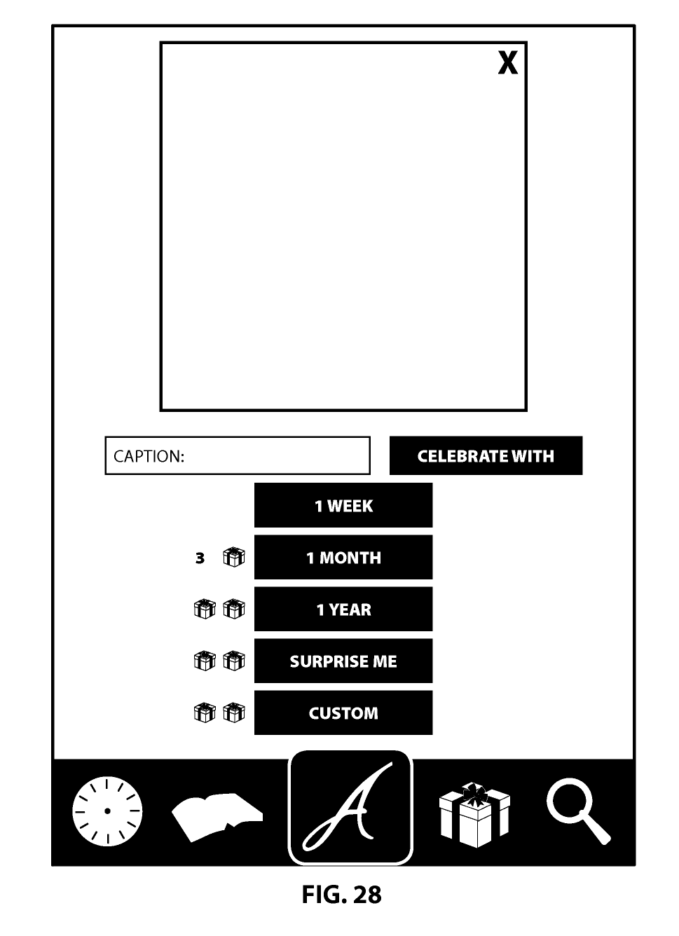

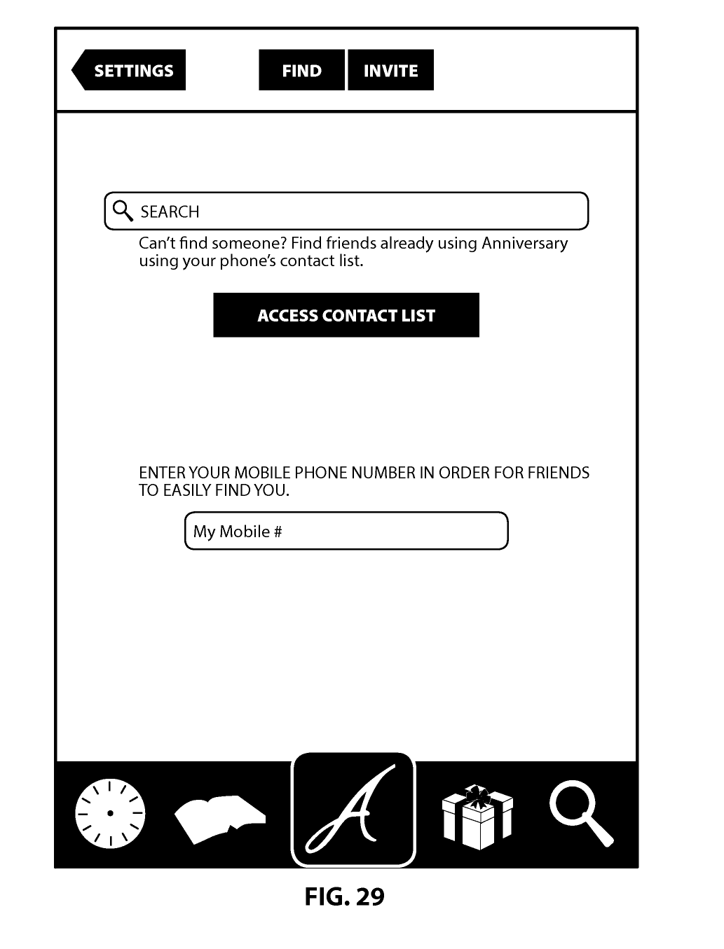

FIG. 27 may be particularly provided when the user has yet to receive his/her first Anniversary. FIG. 28 may appear when a user has scrolled through to the end of an Anniversary Album of another. FIG. 29 is illustrative of a main page, from which a user may access the foregoing and the following features upon log-in.

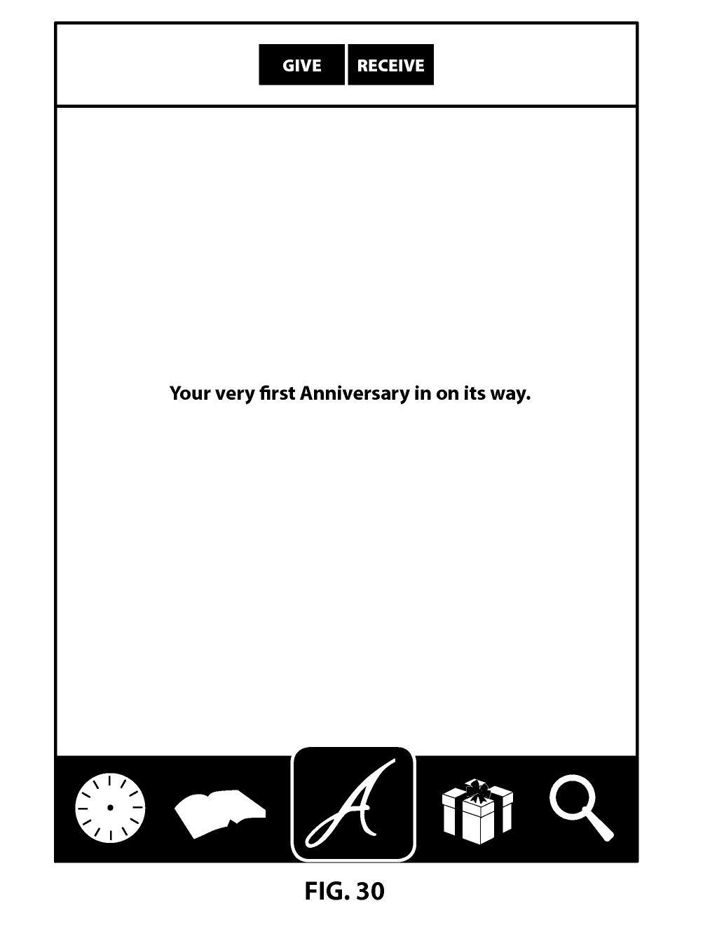

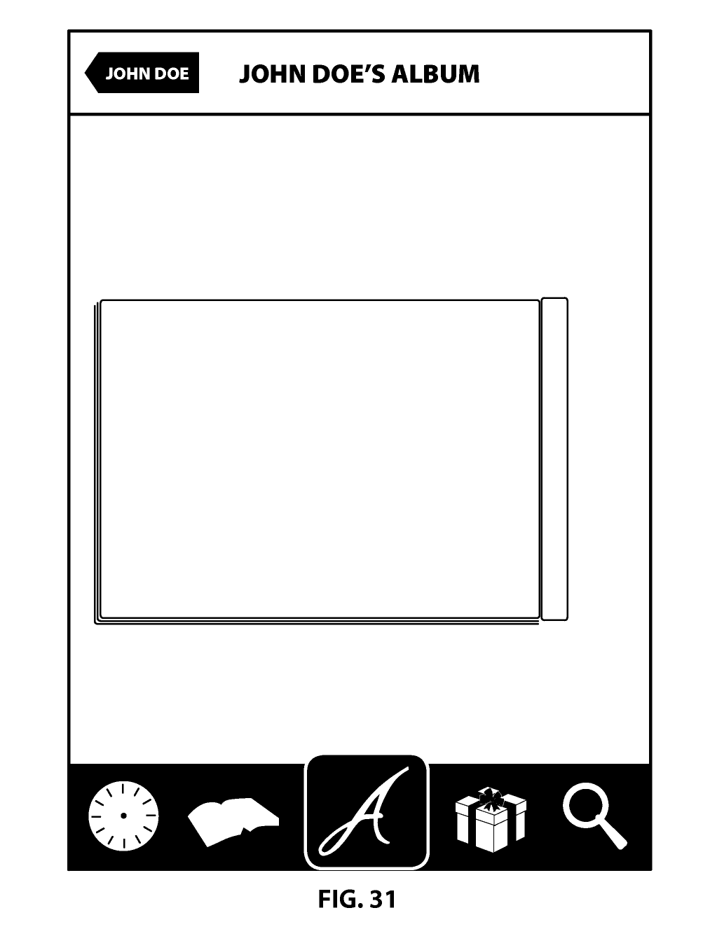

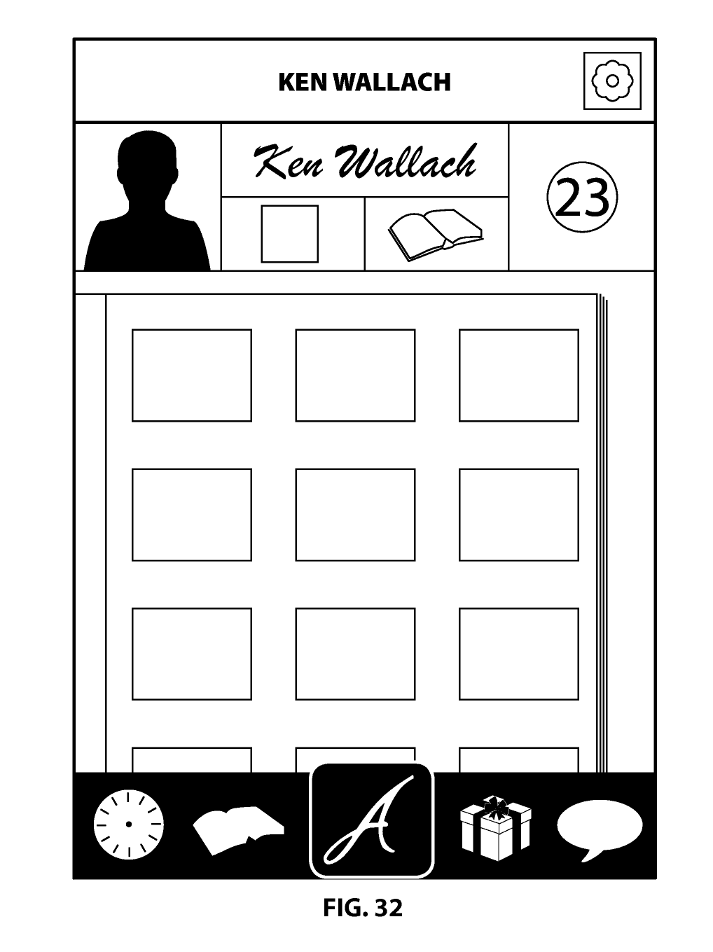

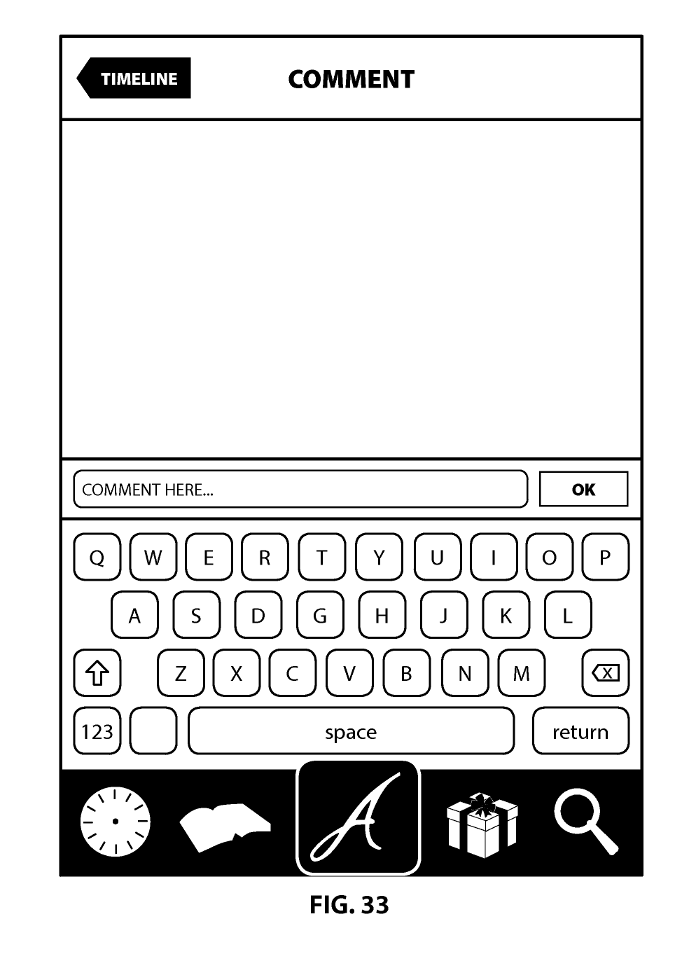

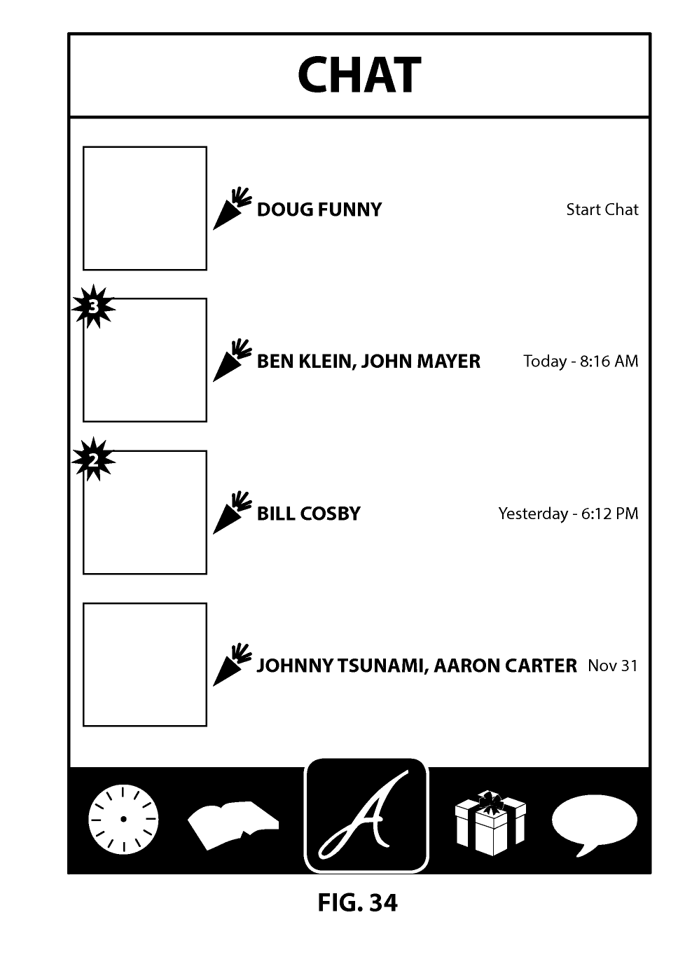

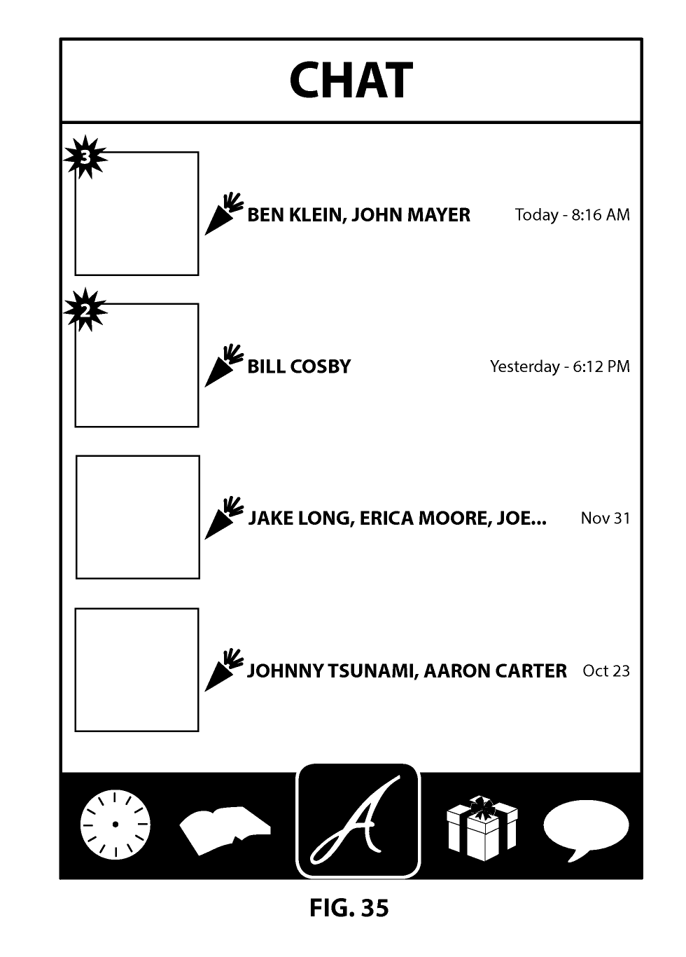

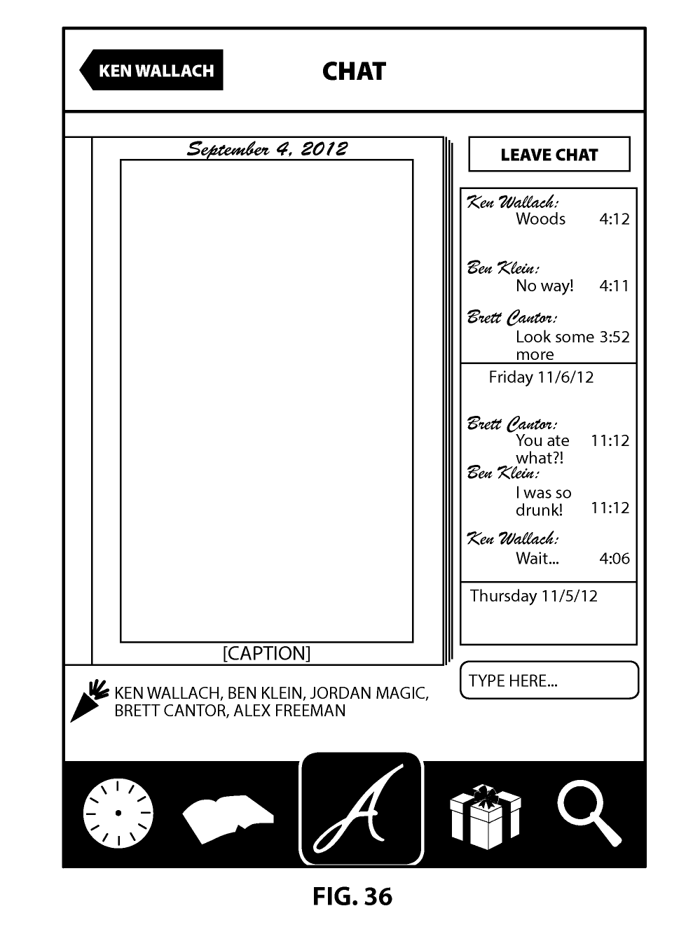

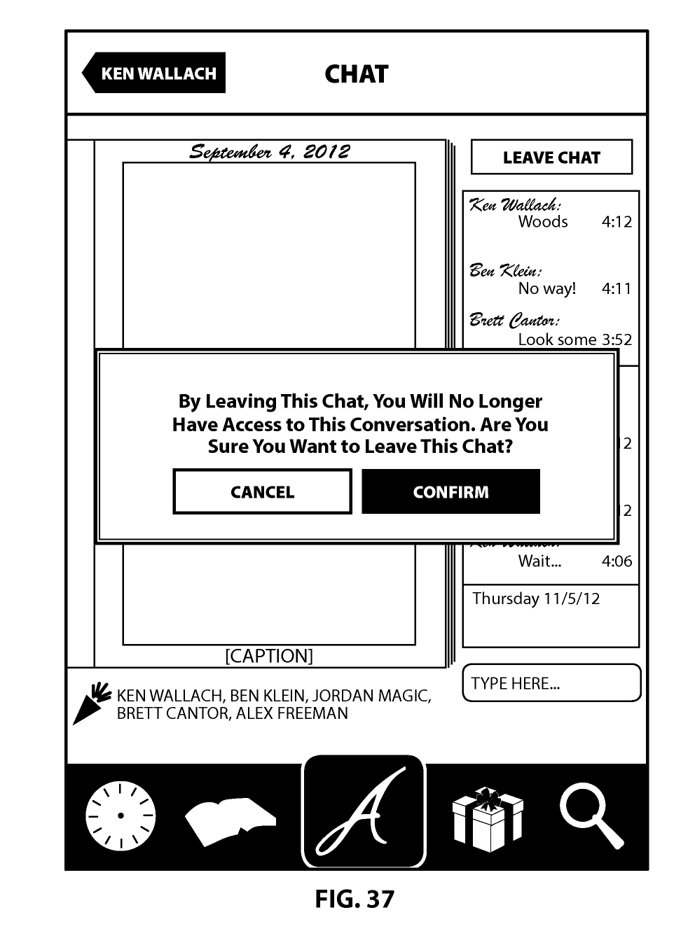

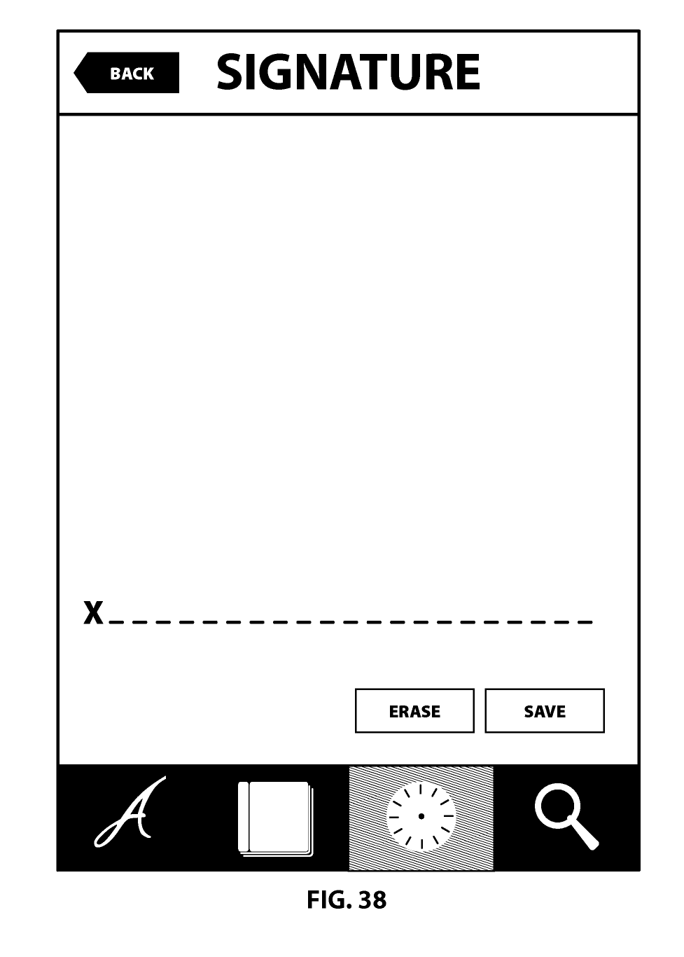

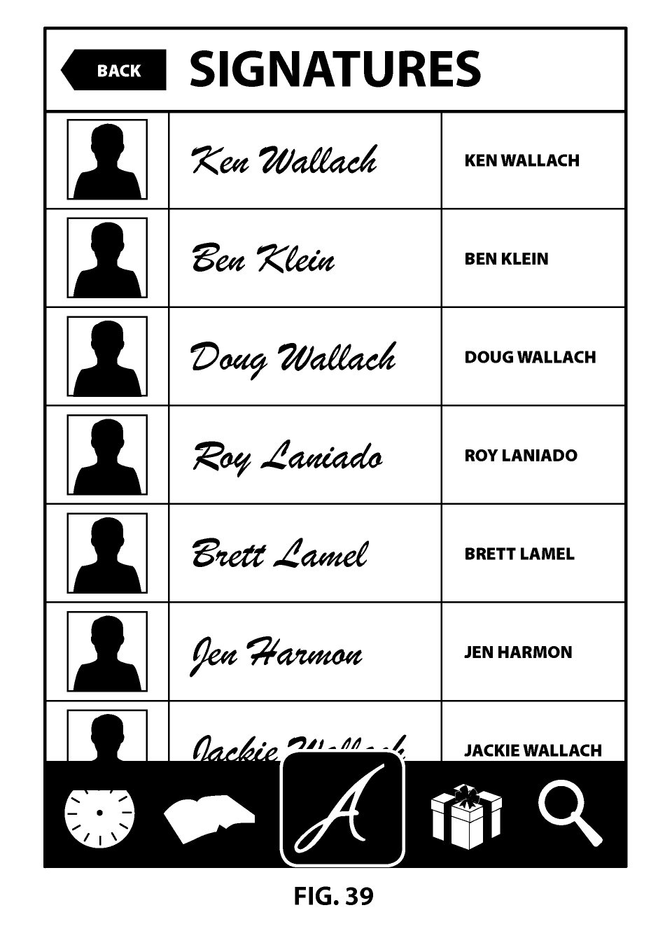

As discussed, a user may comment on, or chat regarding, an Anniversary. For example, when a user clicks “comment” on an Anniversary, FIG. 30 may be provided. Aspects of the “chat” feature are illustrated in FIGS. 31-34. Further, aspects of a “signature” feature for signing into or onto latent photo deliveries, comments, chats, or the like, are illustrated in FIGS. 21 and 35-39.

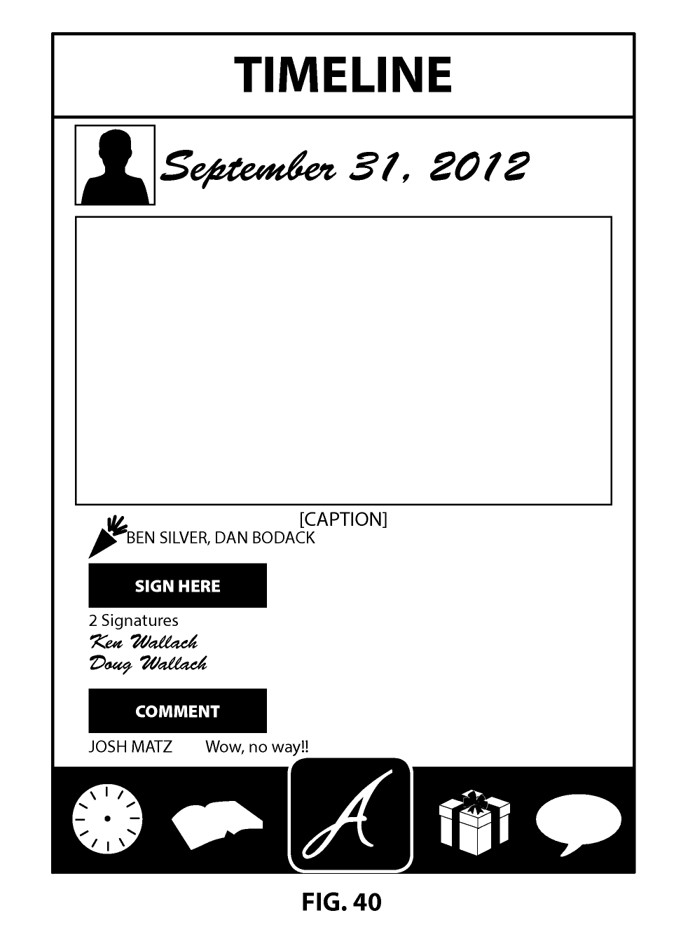

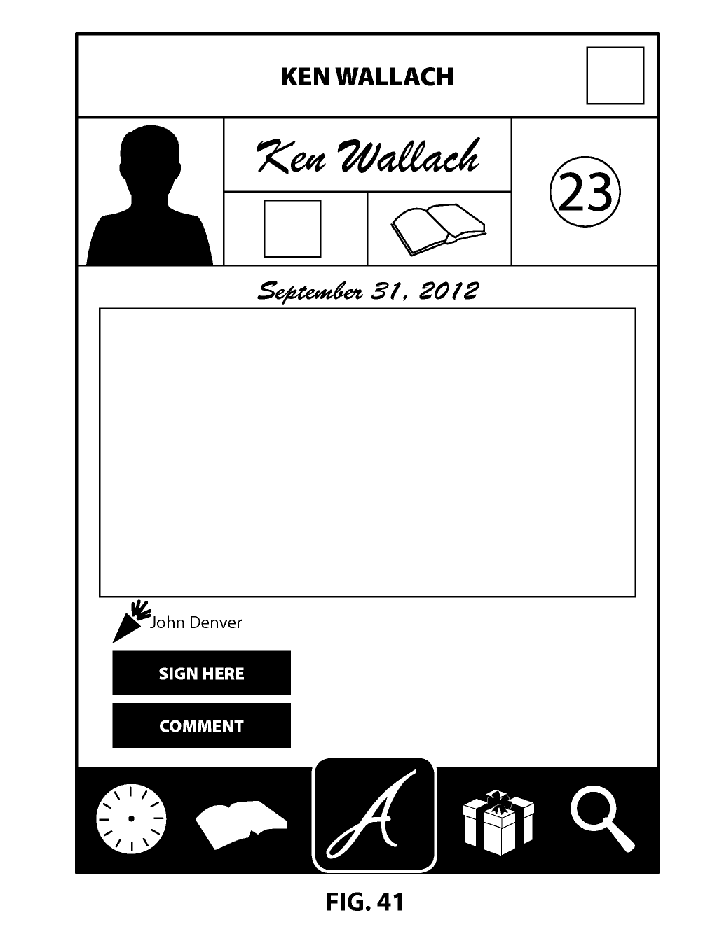

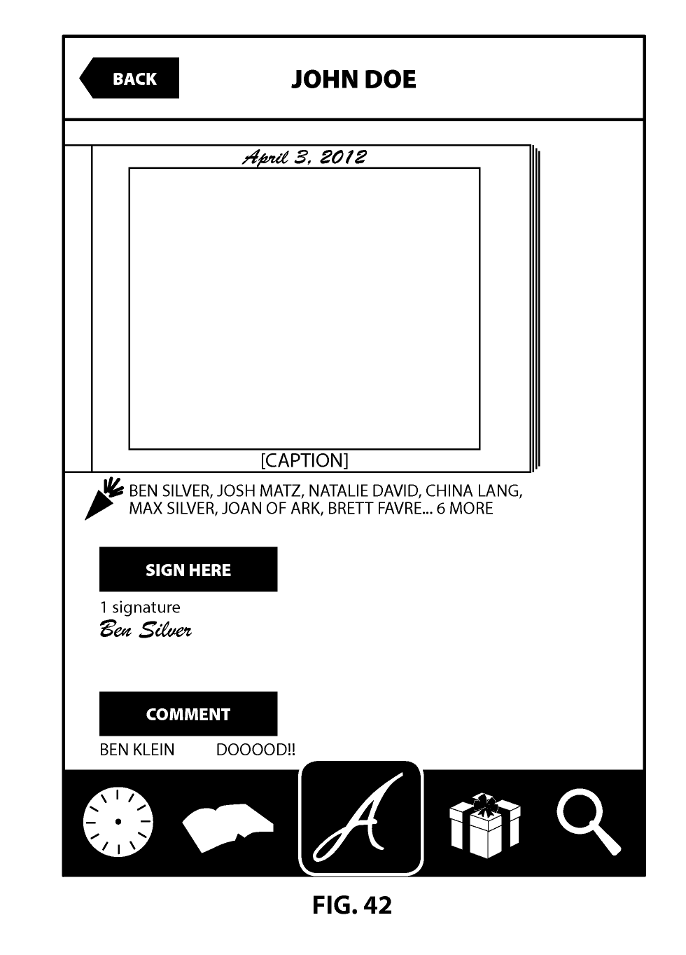

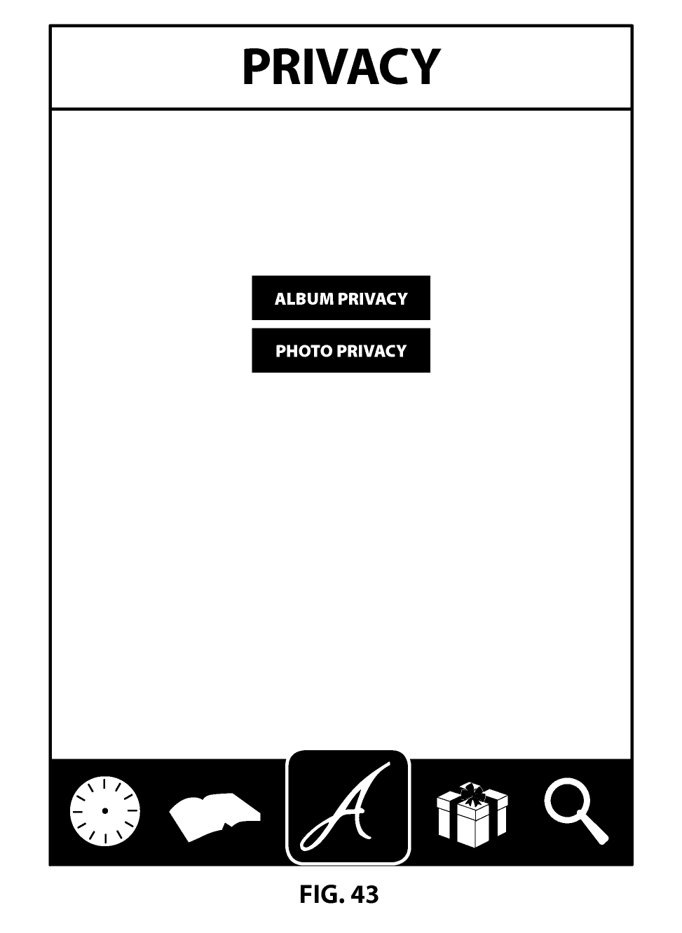

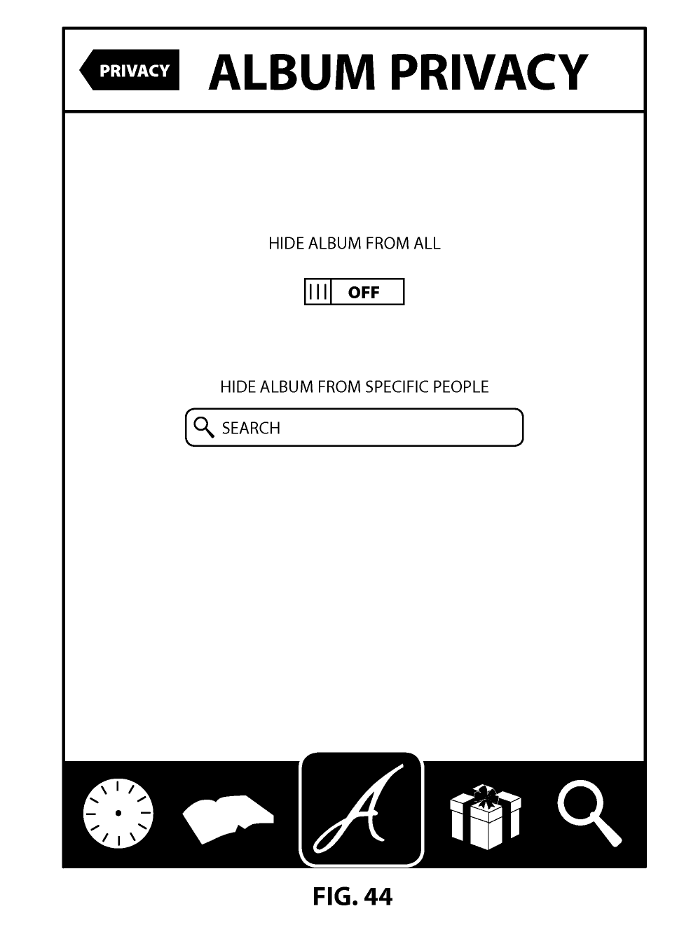

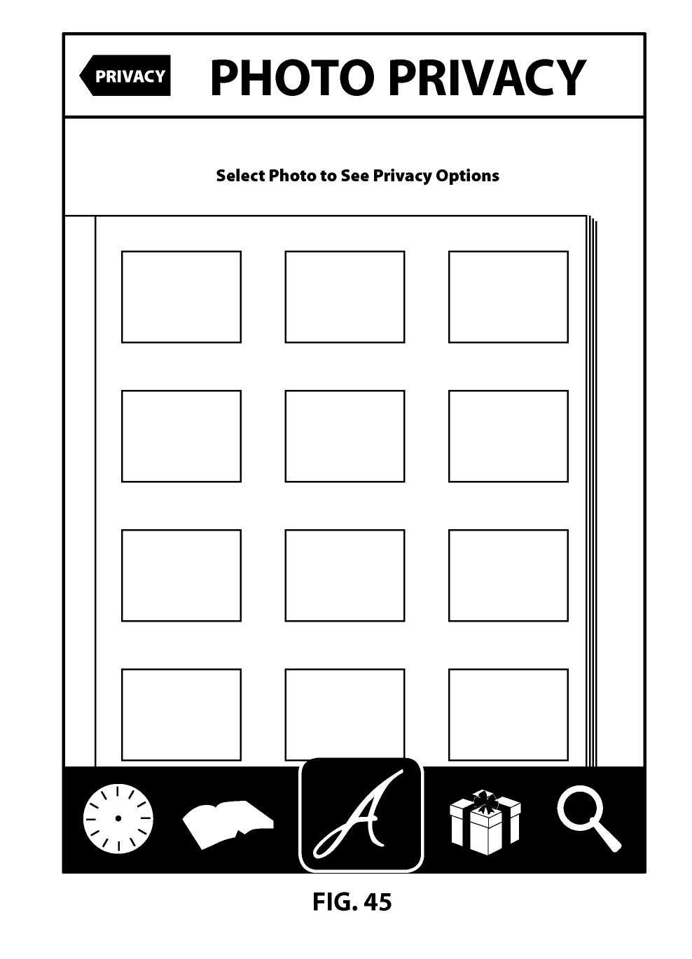

A user may additionally be enabled to set aspects of the invention as private, such as with respect to all users or only with respect to particular other users. Aspects of privacy according to the invention may include those aspects illustrated in FIGS. 40-45.

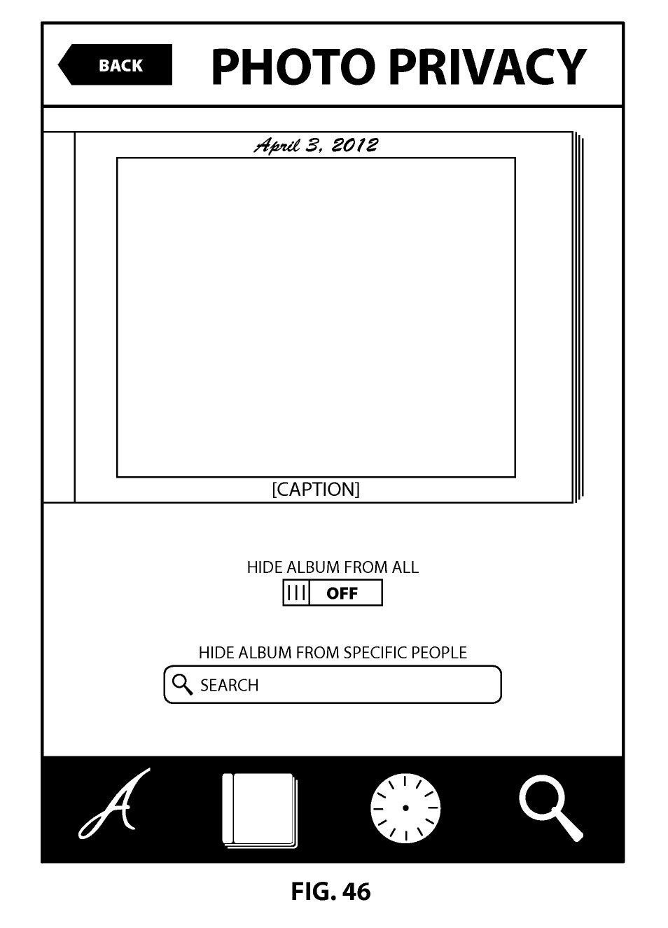

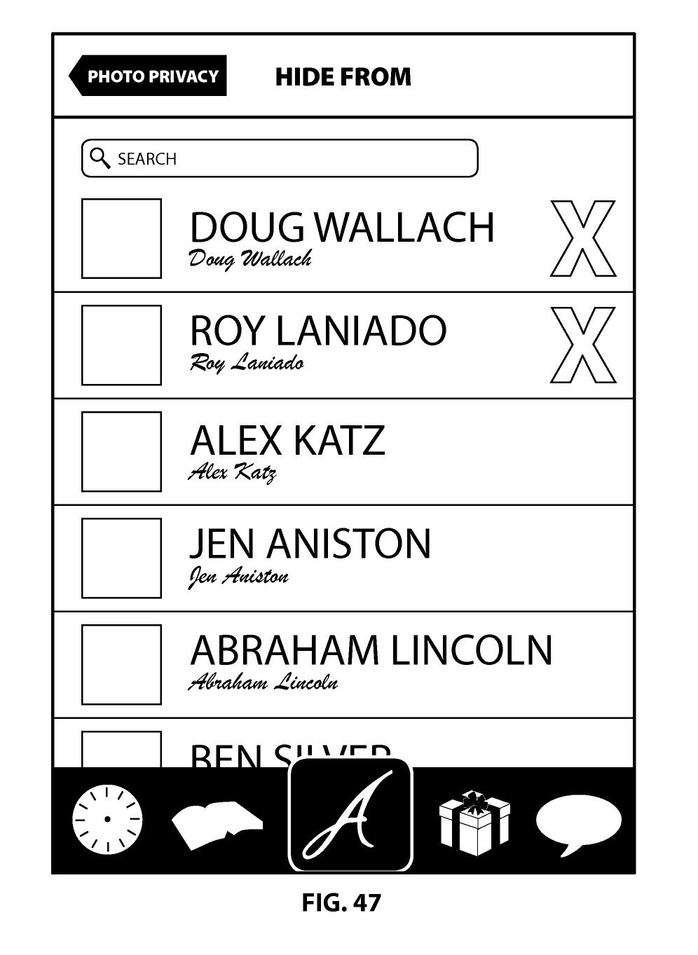

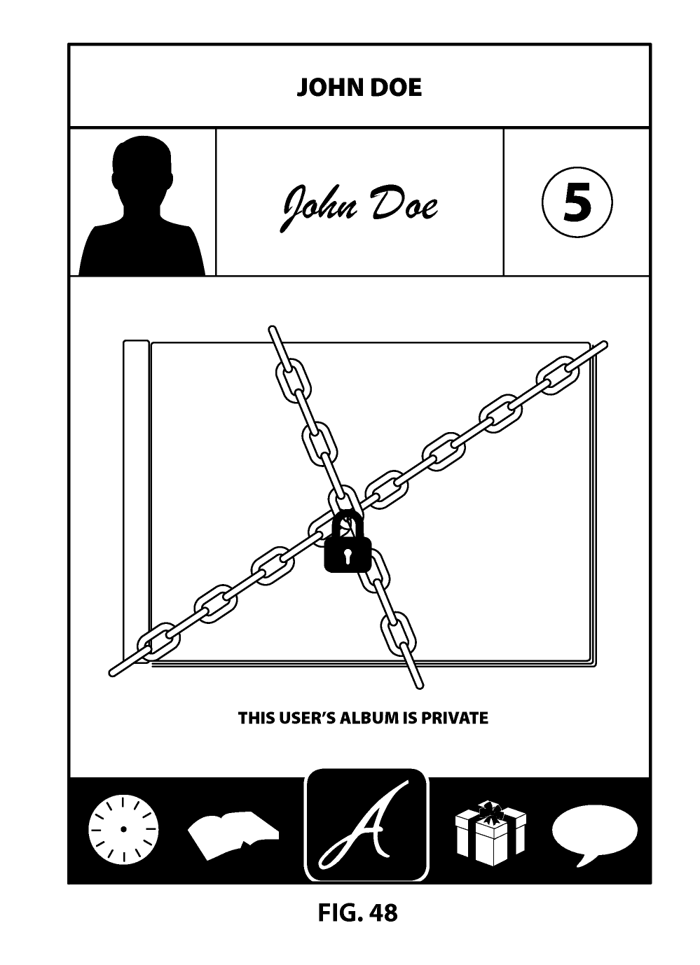

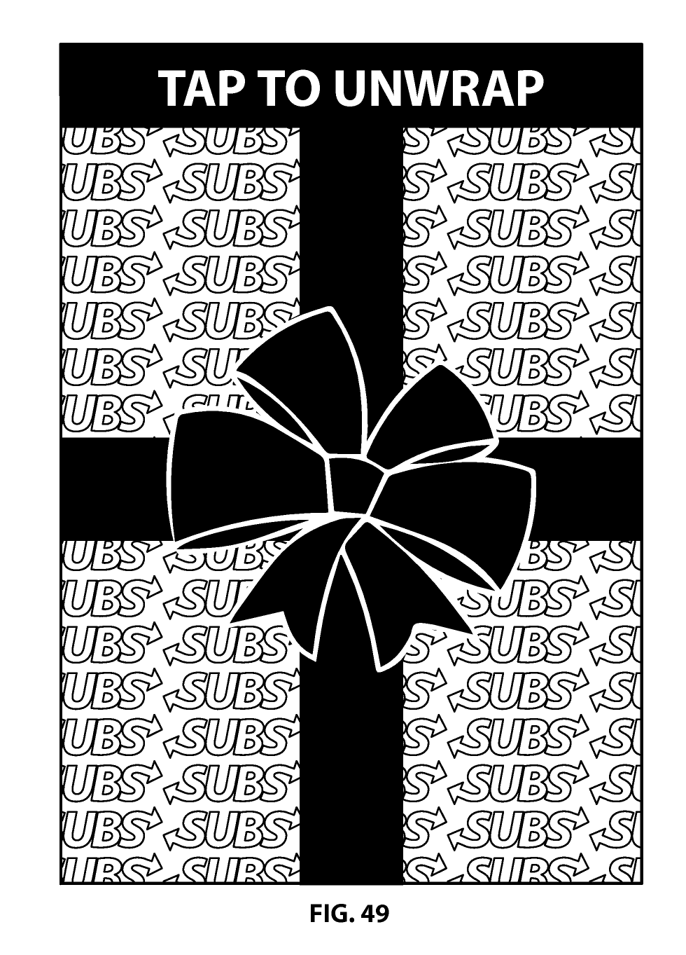

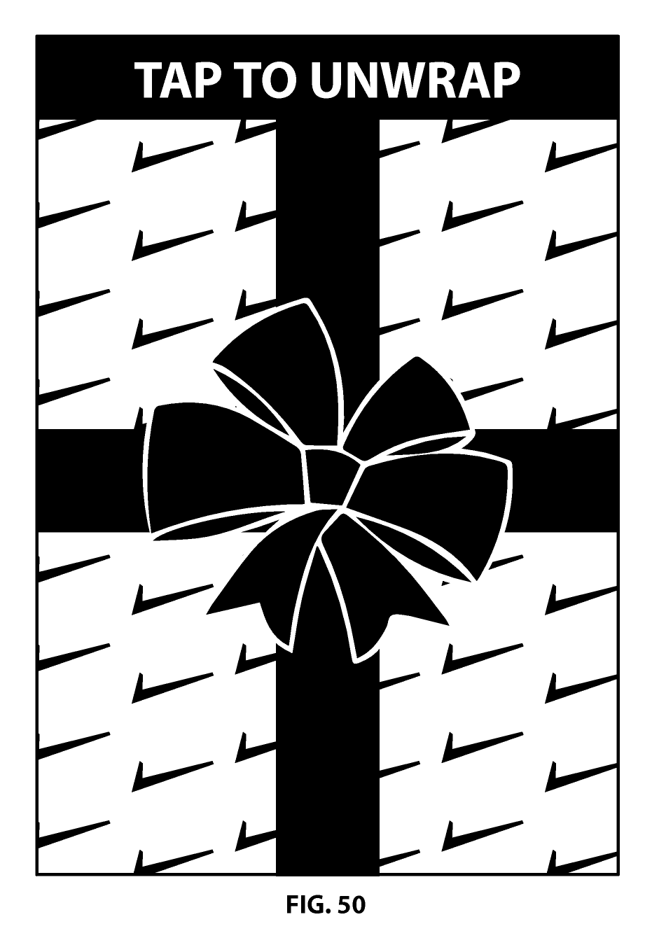

Also of note, those skilled in the pertinent arts will appreciate that the herein disclosed latent and recurring remembrance apparatus, system and method may be provided free of charge or for a charge, such as in a for-charge app. Further, in aspects, monies may be achieved by the instant invention via placement of banner ads, pop-up ads, or the like. Moreover, sponsorships, such as for gifts, may be obtained by sponsors. For example, a latent remembrance gift may be provided to a user “wrapped” in a sponsor's “wrapping paper,” as is illustrated in FIGS. 46 and 47. Further, such a gift wrap may include a gift from the sponsor, or an embedded ad for the sponsor in the latent memory. Additionally, advertising, sponsors, and the like may be based on a user's profile indications, a user's use indications (of an app according to the invention, or of other apps), and/or a geography of a user, a photo, a recipient, or the like.

In a more particular example, the invention may provide an interactive screen, in accordance with the foregoing, wherein interaction with the initial interactive screen may lead to the reveal, partial reveal, or like providing of the latent memory. As such, the initial interactive screen or screens may be akin to a physical “unwrapping,” as discussed above, of the latent memory in a like manner to that in which a recipient might unwrap a physical gift. As such, the initial interactive screen may provide sponsorship opportunities, such as in the form of the sponsored “wrapping paper” illustrated in FIGS. 46 and 47. Accordingly, the user may interact, such as by touching particular locations, swiping a finger or fingers, or the like, the partially or completely “tear” away the wrapping to reveal the latent memory.

Although the herein disclosed systems and methods have been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

1. A method for providing latent triggers for celebrating an event associated with image content, the method comprising:
capturing the image content on a device;
receiving timing information associated with the image content; and
presenting the image content in accordance with the received timing information.
